(19) United States
(12) Patent Application Publication
(10) Pub. No.: US 2025/0307390 A1
(43) Pub. Date: Oct. 2, 2025

(54) FINGERPRINT SECURITY OF A MACHINE-LEARNING TOOL

(71) Applicant: THIA ST Co., Corvallis, OR (US)

(72) Inventors: Elaine Kelsey, Corvallis, OR (US); Sazzad Mahmud Nasir, Muncie, IN (US); Elliot Nicholas Robson, Seoul (KR); Jeffrey Thomas Yarbro, Memphis, TN (US); Lauren Elizabeth Egerton, New York, NY (US)

(73) Assignee: THIA ST Co., Corvallis, OR (US)

(21) Appl. No.: 19/088,242

(22) Filed: Mar. 24, 2025

Related U.S. Application Data
(63) Continuation of application No. PCT/US25/20855, filed on Mar. 21, 2025.
(60) Provisional application No. 63/571,955, filed on Mar. 29, 2024.

(51) Int. Cl. G06F 21/55

(52) U.S. Cl. CPC G06F 21/554; G06F 2221/033

(57) ABSTRACT

Methods and apparatus are disclosed for providing security for a target machine-learning (ML) tool and its host system. Input data is fed in parallel to a second ML tool. Fingerprints of the second ML tool are used to monitor changes in the second tool. Fingerprint changes above a threshold indicate anomalous input data and warn of possible threat to the target tool. Anomaly detection enables diagnosis and remediation. Compact fingerprints are easy to handle, and hide details of the underlying tool. Concurrently, fingerprints are large enough to be sensitive to localized variations within the tool. Alternative embodiments monitor fingerprints of the target tool itself. Further embodiments monitor input or output data streams for sensitive data using a trained ML classifier. Variations and applications are disclosed.

### CROSS REFERENCE TO RELATED APPLICATIONS

This application is a Continuation of PCT/US2025/020855 which claims the benefit of U.S. provisional patent application 63/571,955 filed on Mar. 29, 2024, both of which are incorporated herein by reference in entirety.

### BACKGROUND

As machine-learning (ML) tools become more widely deployed, attacks on these tools and their associated environments also increase. These tools include, without limitation, copilots, large language models (LLM), multi-modal models (LMM), numerous tools described as “artificial intelligence,” as well as earlier generations of machine-learning tools. Systems incorporating such tools are deployed, or are expected to be deployed, in a wide range of applications including business applications, chatbots, creative arts, education, financial applications, gaming, industrial applications, intelligence and counter-intelligence, logistics, medical applications, military applications, research, search engines, social media, software development, vehicle automation, and more. All of these systems are at risk. Some threats have been classified as adversarial attacks, data poisoning, prompt engineering, or backdoor attacks. Numerous instances of attacks have been documented. However, many such tools are based on open-source technology, have input or output ports that are public, or may rely on public data for training. As such, attacks can enter through legitimate channels, and conventional security through access control can provide only limited protection. The systems incorporating such tools may introduce additional vulnerabilities. Accordingly, there remains a need for improved technologies for detecting or preventing attacks on these tools and systems.

### SUMMARY

In a first aspect, disclosed technologies can maintain a fingerprint associated with a target machine-learning tool. Variations in tool behavior can be correlated with fingerprint changes, and a threshold fingerprint change can be established. Over time, as the tool evolves through incremental training, including reinforcement learning, the fingerprint of the tool can be monitored. A fingerprint change exceeding the threshold can be flagged and an alert can be issued, following which remedial or diagnostic action can be taken.

In a second aspect, disclosed technologies can apply similar techniques to target data streams which are inputted to or outputted from a first machine-learning tool. The target data streams can be inputted to a second machine-learning tool operating in training mode. Fingerprint variations in the second tool can be monitored, in a similar manner as for the first aspect, and variations exceeding a predetermined threshold can be flagged as an indication of anomalous data in the target data stream. The second machine-learning tool can be a large language model

In a third aspect, disclosed technologies can protect against leakage of private or sensitive domain data in a target output data stream from a first machine-learning tool. Domain data can be labeled according to whether each data item should be blocked from tool output, and a second machine-learning tool can be trained as a classifier using this labeled data. The second machine-learning tool can also be trained for language skills in order to recognize context in which a particular data item is found. To illustrate with an example where individual's birth dates are private: “John's experience is noteworthy. His life began on Dec. 2, 1995” can be blocked as disclosing John's date of birth, while “John set out for Birthday Lake on Dec. 2, 1995” can be permitted. Upon encountering impermissible data in the target data stream, an alert can be flagged, the impermissible data can be deleted or redacted, or diagnostic action can be taken.

These and other technologies can be specialized to detect particular types of threats, to protect specific components of a copilot, or to monitor particular modes of input data. Specialized security tools disclosed herein can sometimes be combined to provide more comprehensive protection than any single tool can provide by itself.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic diagram of an example architecture of a copilot incorporating security features according to the disclosed technologies.

FIGS. 2A-2C together constitute a schematic diagram of an example architecture of a copilot to which the disclosed technologies can be applied.

FIG. 3 is a diagram of another example copilot to which the disclosed technologies can be applied.

FIG. 4 is a flowchart illustrating example operation of a copilot.

FIG. 5 is a flowchart of a first example method for providing security protection according to the disclosed technologies.

FIG. 6 is a dataflow diagram for some implementations of the first example method.

FIG. 7 is a schematic diagram illustrating an example of fingerprint calculation according to the disclosed technologies.

FIGS. 8A-8B are diagrams illustrating further clustering examples for fingerprint calculation according to the disclosed technologies.

FIG. 9 is a flowchart of a second example method for establishing security protection according to the disclosed technologies.

FIG. 10 is a flowchart of a third example method for providing security protection according to the disclosed technologies.

FIG. 11 is a flowchart of a fourth example method for providing security protection according to the disclosed technologies.

FIG. 12 is a diagram schematically depicting a computing environment suitable for implementation of disclosed technologies.

FIG. 13 is a diagram schematically depicting computing devices operating in conjunction with a computing cloud for implementation of disclosed technologies.

### DETAILED DESCRIPTION

### Introduction

Like other software or Internet applications, machine-learning (ML) tools are subject to attack. Because of their internal complexity, ML tools' behavior is not always predictable. Some ML tools can be tricked into giving undesirable output, e.g. through malicious or careless prompt sequences. ML tools can also evolve through training, including reinforcement learning, over their operating life. The disclosed technologies provide solutions for detecting anomalous behavior, which can facilitate diagnosis and remediation.

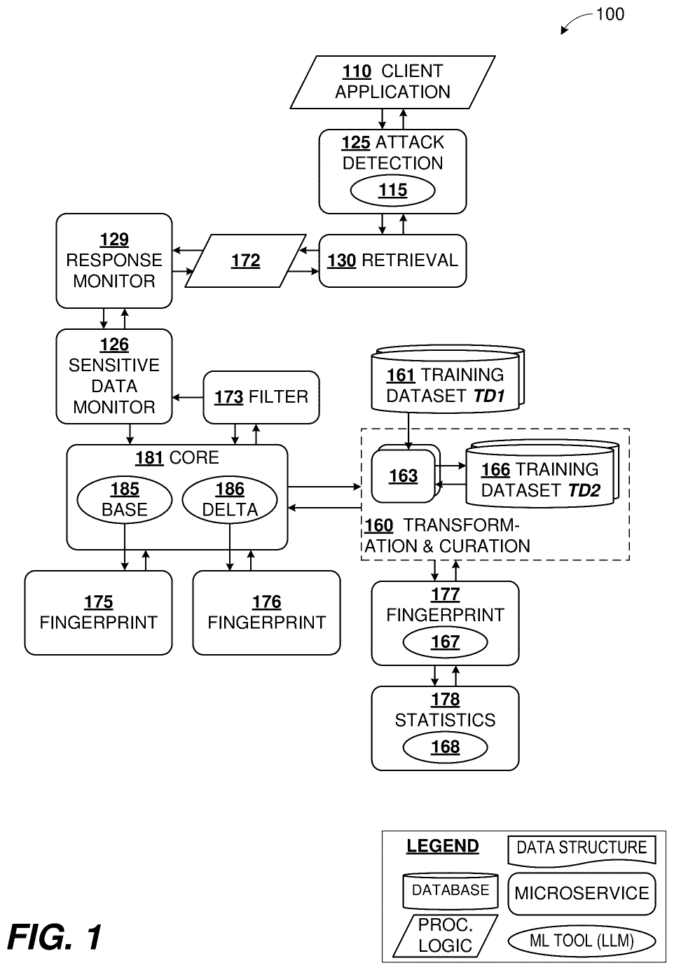

FIG. 1 is a schematic diagram 100 of an example architecture of a system, such as a copilot, incorporating ML tools and security features.

Core microservice 181 can incorporate one or more LLMs, and can be trained to perform inference. For training, model 181 can receive training data originating in one or more training datasets TD1 161, which can be passed through one or more microservices 163 of transformation and curation subsystem 160 to obtain one or more refined training datasets TD2 166. Transformation can include preprocessing activities such as removing email headers, spell-check, or conversion from one language or data mode to another. Curation can refer to qualifying data from training dataset 161 according to relevance for an instant training objective. Inasmuch as training data provides one avenue of possible attack, the path 161->160->181 is a suitable place to apply disclosed technologies.

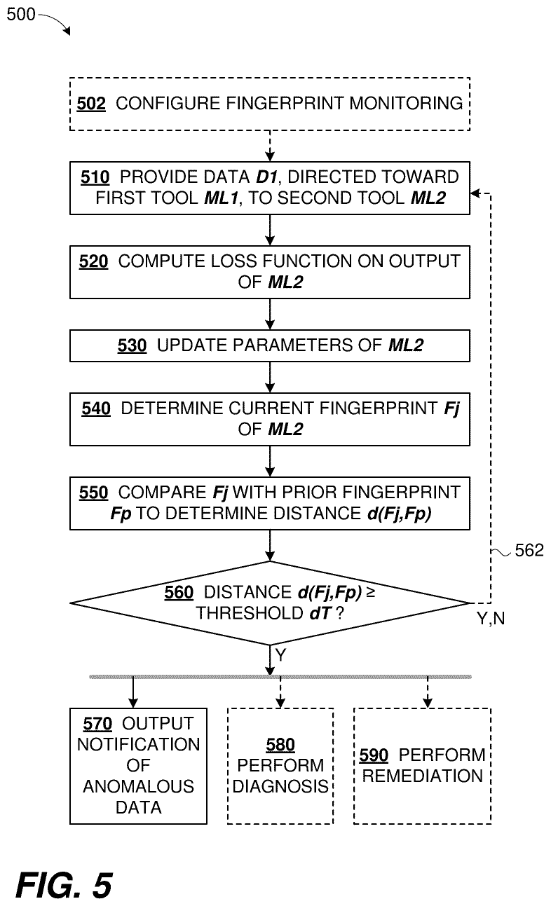

Microservice 177 can be supplied with training data TD2 directed toward core microservice 181 and can implement a fingerprint detection technique as described e.g. in context of FIGS. 5-10 below. The fingerprint can be in the form of a graph, and changes to the fingerprint can be used to detect anomalies in training data directed toward core 181. Additionally or alternatively, statistical analysis of the training data can be performed by microservice 178. Microservices 177, 178 can be implemented using respective LLMs (or other ML tools) 167, 168.

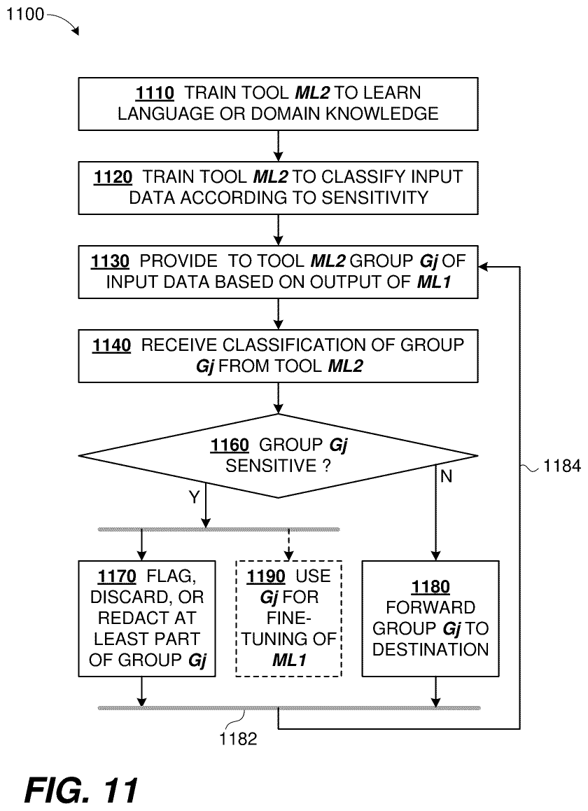

For security during inference, core microservice 181 can receive data from a client, illustrated as client web application 110. As shown, the path from client 110 to core microservice 181 can pass through microservices 125, 130, 172, 129. Microservice 125 can monitor client data in one or both directions in conjunction with one or more ML tools (which can be LLMs) 115, implementing disclosed technologies such as fingerprint techniques described in context of FIGS. 5-10 below. Microservice 130 can support retrieval augmented generation (RAG) and can augment data received from client side with data retrieved from one or more data producers (not shown). Microservice 172 can manage one or more prompts (e.g. a prompt stream) directed toward core microservice 181, and microservice 129 can monitor responses originating at core microservice 181. In varying examples, microservice 129 can: evaluate whether responses adequately address a received prompt; whether additional iteration between prompting layer 172 and core 181 is required; cache prompts and responses; or gather performance statistics. Microservice 126 can detect sensitive information, in one or both directions, according to disclosed technologies such as described in context of FIG. 11 below. In examples, microservice 173 can provide bias or toxicity filtering on output from core microservice 181 en route to microservice 126.

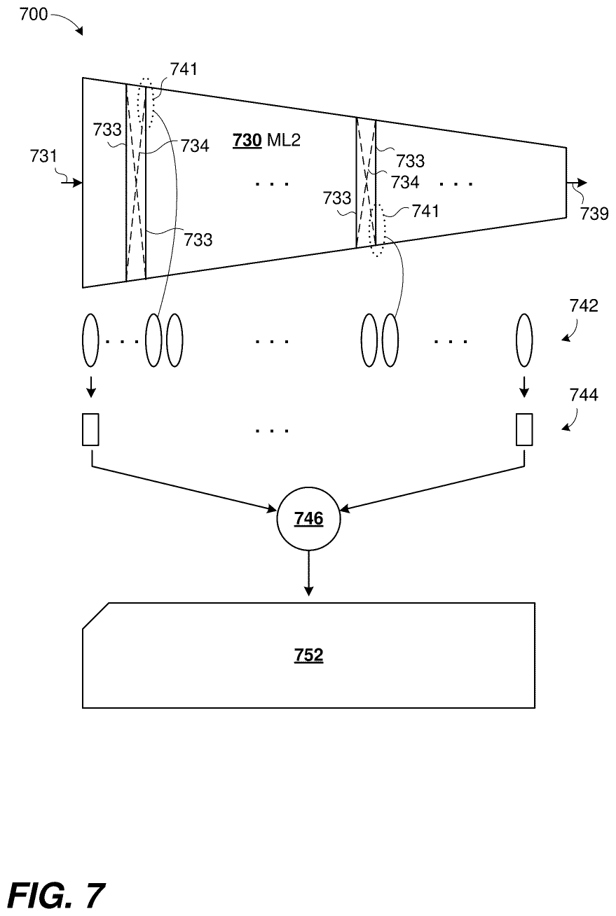

Disclosed fingerprint techniques can also be applied directly at core microservice 181. During training, fingerprints of one or more ML tools within core 181 can be generated or monitored by microservice 175 or 176, similar to techniques described in context of FIGS. 7-10 below.

In some examples, a base ML tool 185 can be customized for a particular deployment, and the resulting change in the ML tool's weights (or other parameters) can be represented by a delta ML tool 186 as shown schematically in FIG. 1. As described further herein, fingerprint microservice 175 can provide disclosed fingerprint support for base ML tool 185 (which can be in the form of a lossy fingerprint with light computational footprint, suitable for real-time monitoring), and fingerprint microservice 176 can provide disclosed fingerprint support for delta ML tool 186 (which can be in the form of a low-loss high-fidelity fingerprint providing high sensitivity). Notably, fingerprint microservices 175, 176 can also be customized independently, so that two deployments of a given ML tool (e.g. base ML tool 185, or delta ML tool 186) can have distinct or unique fingerprint definitions.

The architecture of FIG. 1 is exemplary. Many other architectures can be implemented within scope of the disclosed technologies. Particularly, more, fewer, or different instances of security microservices (e.g. 177, 178, 125, 126) can be implemented, using disclosed innovative techniques and optionally other techniques.

ML tools described herein include, without limitation, copilots, large language models (LLM), multi-modal models (LMM), numerous tools described as “artificial intelligence,” as well as earlier generations of machine-learning tools. ML tools can be deployed in a wide range of systems for applications including, without limitation: business applications, chatbots, creative arts, education, financial applications, gaming, industrial applications, intelligence and counter-intelligence, logistics, medical applications, military applications, research, search engines, social media, software development, vehicle automation, and more. All of these systems can benefit from disclosed techniques.

### Terminology

To facilitate review of the various embodiments, the following explanations of terms are provided. Occasionally, and where clear from the context, a term may also be used in a different meaning.

The term “anomalous” refers to: behavior of a machine-learning tool that is outside its designed or specified behavior; a fingerprint or output data associated with such behavior; or input data engendering such behavior.

An “attack” on a software tool is an attempt to compromise or overcome security of the software tool. Inasmuch as security can include protection of confidential inner workings of the tool, some attacks can attempt to detect aspects of such inner workings. Inasmuch as security can include prevention of unauthorized modifications to the tool, some attacks can attempt to change behavior of the tool, e.g. so that the tool provides incorrect or unintended output. Other attacks can attempt to compromise other aspects of the tool's security. An attack need not be successful to be termed an attack. A “threat” can be an attack, or behavior indicative of a possible attack.

An “attention mechanism” generates an output with weighted contributions from input tokens according to one or more keys. A key vector Kᵢ that closely matches a sequence of input tokens can result in a high weight wᵢ, while a poor match can result in a low weight. The weight wᵢ for each key vector Kᵢ can be applied to a respective value vector Vᵢ, and summed to obtain an output vector O=Σwᵢ·Vᵢ.

An “average” is a representative value of a group of like quantities. While an average is often an arithmetic mean, this is not a requirement: the term average encompasses, without limitation, a filtered value, geometric mean, harmonic mean, median, mode, moving average, or other representative value. Inasmuch as an average reflects a commonality among the like quantities, other measures (“measure of variation”) can reflect divergence among the like quantities. Measures of variation can include, without limitation: standard deviation, variance, range (e.g. maximum minus minimum), interquartile range, or full-width haf-maximum (FWHM; of an associated distribution). The group of like quantities can be weights associated with edges or nodes of a neural network or another form of ML tool.

The “cardinality” of a software entity such as a data structure, fingerprint, or machine-learning tool is a number of variable atomic data objects defining the entity. Thus, the cardinality of a data structure or fingerprint can be a number of atomic elements in its definition or instantiation. The cardinality of a neural network or other machine-learning tool can be the number of weights or other trainable parameters it contains. Atomic data objects can include binary variables, categorical variables, integers, floating point numbers, pointers, and strings. Images, arrays, documents, and audio segments are not atomic data.

“Classify” refers to an act of assigning one or more classes (which can be labels) to a finite data input. A machine-learning tool can be configured as a classifier. An assigned class is a “classification” of the respective data input.

A “client” is a hardware or software computing entity that uses a resource provided by another hardware or software computing entity such as a copilot. A “client interface” is a software component within a copilot which receives input from or provides output to a client. Disclosed copilots can support one or more client interfaces. Often, client output is provided to a same client from which client input was received, but this is not a requirement. Some copilots can be used to mediate interactions between two distinct clients: language translation between two clients is just one example. Examples of the disclosed technologies can support additional client interfaces for management functions, including e.g. monitoring, human evaluation, human feedback, fine-tuning, supplemental training, updates, or other control.

In the context of fingerprints, a cluster can be a group of ML tool parameters (e.g. weights associated with edges in a neural network). The parameters included in a cluster can be grouped in various ways. Parameters along a path from an exposed input layer to an exposed output layer are dubbed a “chain”. A path between a hidden layer and an exposed layer (or between two hidden layers does not form a chain. A group of chains is dubbed a “tube”. Chains in a tube can be disjoint, can share common edges, or can pass through common vertices of a neural network, in any combination.

A “measure of connectivity” can be defined for a single vertex of a graph, a group of vertices, a group of edges, or an entire graph, and can indicate a representative number of vertices from which a given vertex received input, to which the given vertex provides output, or with which the given vertex is directly connected. Generally, the greater the ratio of edges to vertices, the greater the connectivity. Thus, a disjoint vertex or group of vertices (minimal edges) can have low connectivity, and a fully connected group of vertices (maximal edges) can have high connectivity. Applied to a group of edges, connectivity can be related to the number of the edges having weight greater than zero, greater than a median weight, or greater than a threshold value.

A “copilot” is a software tool providing knowledge-based assistance to a user in the furtherance of some task. Some disclosed copilots can be implemented as a “microservice network,” which is a collection of microservices connected in a directed graph. In response to a client input, data can be processed and transmitted among the microservices, until an output is returned. While responses to client input often result in output to a client, this is not a requirement. In some examples, a client input can result in internal updates e.g. to parameters of an ML tool, to copilot configuration, or to an internal database. A path through the microservice network along which data propagates in response to the client input is dubbed a “flow.” The process of coupling microservices to form the copilot is dubbed “assembly.” In examples, the coupled microservices can be customized, before or after assembly, resulting in a copilot customized for a particular application. A “deployed” copilot can be used for inference, developing and returning outputs in response to fresh (not previously seen) client inputs. However, a deployed copilot can also be subject to occasional incremental training. In some examples, the deployed copilot can be a snapshot of a master version. As the master version is incrementally trained, a new snapshot can replace the previous snapshot. Update of the deployed copilot can be performed by taking the copilot offline during a maintenance interval. Alternatively, a hot swap can be performed. After training, assembly, or update, one or more copies of a given copilot can be generated, deployed, or further customized. Each of these copies of the given copilot is termed a “copilot instance.”

Within a copilot, a “core microservice” is a microservice whose function is to receive input and provide corresponding output which is of interest to a user at a client. Inasmuch as the intended audience of output from a core microservice is the user or client, a core microservice can be distinguished from other microservices whose intended audience is another microservice such as a retrieval microservice or a core microservice. The user or client focus of a core microservice does not preclude (i) iterative invocation of one or more core microservices or (ii) routing of a core microservice's output through other microservices such as qualification or evaluation microservices. Moreover, invocation of these other microservices can, in some instances, lead to all or part of the core microservice's output being discarded or otherwise failing to reach a user or client. In some examples, an ensemble of core microservices can cooperate.

A “corpus” is a collection of documents which contain knowledge of one or more domains. A “general corpus” is a corpus which illustrates use of a language but is not specific to any given target deployment. Non-limiting examples of generic corpora include: an encyclopedia, a library, or an archive of one or more publications. A “target-specific corpus” (or simply “target corpus”) is a corpus which contains knowledge specific to a knowledge domain in which a copilot is, or is desired to be, proficient. Non-limiting examples of target-specific corpora include a corporate database; textbooks, publications, or other literature in the target domain; or proprietary documents (e.g. manuals, presentations, training materials).

A “CPU” (or, central processing unit) is a general-purpose computer processor, which can have one or more processor cores. The term CPU encompasses complex instruction set computer (CISC), reduced instruction set computer (RISC), specialized processors in the form of application-specific integrated circuits (ASIC), or embodiments in field-programmable gate arrays (FPGA). The term “GPU” (or, graphical processing unit) is used herein to encompass any accelerator or coprocessor, often providing parallel processing capability. A GPU is not limited to chips or coprocessors marketed as graphical processors. CPUs, GPUs, nodes, clusters, or other computing resources described herein can variously be implemented as stand-alone laptop, desktop, or workstation computers at a customer or client premises; at a data center; or in the cloud. The term “processor” encompasses CPUs and GPUs.

The unqualified term “data” refers to any digital representation of information.

In the context of dataflow for processing input from a client to generate output, the term “discard” refers to removing data from that dataflow, so that the discarded data does not contribute to the generated output. Discarding data does not require that the data be deleted. Discarded data can also be used for subsequent training, e.g. by reinforcement learning with or without human feedback.

In the context of a threat or attack, “diagnosis” refers to acts which attempt to determine one or more sources, techniques, instances, effects, or other aspects of such threat or attack.

Within a copilot, an “expansion microservice” is a microservice whose function is to receive tokens of client input and provide additional related tokens. With these additional tokens, a retrieval microservice can gather additional documents. With the additional tokens or the additional documents, a core microservice can generate additional or improved responses. An expansion microservice can be implemented using a trained ML tool, such as an LLM, LMM, or DNN.

The term “expert,” as a noun, refers to a human or a software tool able to provide responses deemed correct by another, independent, expert, for at least a predetermined percentage of test questions. The predetermined percentage can be in a range 50-99.9%, in some examples greater than or equal to 90%.

“Filtering” refers to an act of testing some data against a condition (“filter condition”) and separating, or separately handling, the tested data according to whether the condition is met. Data meeting the condition can be designated as “conforming.”

A “fingerprint” is a data object characterizing the trainable parameters of a machine-learning tool. A fingerprint can desirably contain less information than the ML tool from which it is calculated, so that the fingerprint cannot be used to reconstruct the ML tool. Thus, a fingerprint can support monitoring an ML tool without exposing any of the tool's parameters. Additionally, a fingerprint can desirably contain enough information to be sensitive to changes, and particularly anomalous changes, in the tool parameters. Fingerprints can be implemented with data structures such as arrays or graphs. A fingerprint having information loss less than or equal to 10% from the ML tool it represents is dubbed a “high fidelity” fingerprint, while a fingerprint losing 30% or more of the information content of the ML tool is dubbed a “lossy” or “low fidelity” fingerprint. Between these ranges, fingerprints are characterized as “intermediate fidelity.” Generally, low fidelity fingerprints can require less storage space than high fidelity fingerprints, and can also be faster to compute. Generally, high fidelity fingerprints can be more sensitive to small or localized changes in a fingerprinted ML tool.

A “graph” is a set of two or more vertices and a set of one or more edges joining respective pairs of the vertices. Examples of the disclosed technologies can be implemented as a “network of microservices” which can be represented as a graph (networks inheriting the attributes of graphs), with each microservice being a node of the graph, and directed edges indicating that a destination microservice can be invoked from a source microservice. A graph in which a path exists between every pair of vertices is a “connected graph.” A directed graph is “weakly connected” if the underlying undirected graph (e.g. with all directed edges replaced with undirected edges between the same pair of vertices) is connected. To illustrate, a directed graph A->B<-C is weakly connected because its underlying undirected graph A-B-C is connected. A weakly connected network of microservices means that the microservices can work together rather than in isolation.

“Inference” refers to an act of applying a trained copilot or other trained ML tool to process an input into a corresponding output. While inference commonly operates on inputs not previously provided to the trained ML tool, this is not a requirement, and a trained ML tool could intentionally or inadvertently be provided the same input two or more times. While inference commonly provides an output not previously known, this is not a requirement. A trained ML tool can be tested by prompting it with an input and compare the tool's output with a reference.

With regard to a procedure performed repeatedly, an “iteration” is one performance of that procedure. The iterated procedure can include invocation of a particular microservice. Commonly, an invocation of an iterated procedure starts with an “initial iteration” and ends with a “final iteration.” The designation “initial” does not preclude performance of the procedure prior to the initial iteration in a distinct invocation of the procedure, and similarly there can be other invocations of the procedure after the final iteration of a given invocation. Repetitions of the procedure need not be identical. Commonly, values of parameters can vary from one iteration to the next and, consequently, branches and control flow can also vary. Particularly, a final iteration can exit out of an iterative loop without executing all instructions of the procedure. The iterated procedure can be associated with a “stopping condition:” a determination that the stopping condition is met results in no more iterations being performed.

The term “knowledge domain” (or simply “domain”) refers to one or more subject areas of interest in a copilot deployment. The subject areas can be related to each other (e.g. engines and fuels), but this is not a requirement. In some examples, two disparate subject areas can be of interest to users of a copilot and can both be included in the copilot's knowledge domain. Knowledge or data of the knowledge domain can be graphically represented, e.g. as a knowledge graph or in a multi-dimensional space in which vector representations of knowledge tokens are defined. A collection of points in the multi-dimensional space can define a volume in some or all of the dimensions of the space. The volume can be defined in various ways. In some examples, the volume can be required to be convex or free of voids, while, in other examples, the volume can be the smallest volume enclosed by a surface such that all the points are on the surface or interior to the surface. Further, in varying examples, voids within volumes can be allowed or not, the volume can be a composite of disjoint segments, or the surface of a volume can incorporate concave portions. Such a volume of a knowledge domain can approximate a copilot's competency. At least due to limitations of finite corpora available for training or RAG, a copilot may not have perfect knowledge within this volume. Conversely, a copilot can often provide relevant responses for inputs that are close to but outside the volume. Accordingly, a copilot's competency can be regarded as gradually changing near the edges of the volume rather than having a sudden drop-off. In some examples, an “envelope” can be defined based on the volume, variously matching the surface of the volume, extending a predetermined amount outside this surface, or constrained to be inside the surface, in any combination. Such an envelope can be used to compare data inputs or outputs with a copilot's competency.

A “knowledge graph” is a graph data structure, e.g. having nodes and edges, representing some knowledge. In some examples, a knowledge graph can represent the knowledge of a domain (a “domain representation”), such as a corpus of documents or the knowledge domain of a copilot, but this is not a requirement: any collection of knowledge (e.g. a single document) can be represented as a knowledge graph. In examples, nodes of a knowledge graph can represent tokens or concepts, while edges of the graph can represent relationships between the nodes. Each graph edge can be directed and can be labeled according to the particular relationship the edge represents. This too is not a requirement, and other mappings between knowledge and nodes and edges of the graph can also be used. Generally, vector representations can be mapped onto a knowledge graph, e.g. onto a single node, a single edge, or a combination of an edge and the two nodes joined by that edge. Conversely, a knowledge graph can often be dissected into vector representations of its constituent edges and nodes. Knowledge graphs can sometimes be represented visually, e.g. as a “visualization,” for example by mapping each node to a coordinate position in a two-, three-, or higher dimensional space. In examples, each node can be mapped to a coordinate position in a high dimensional space used for vector representations, and the resulting high dimensional map can be projected onto two dimensions for visual perception on a display screen.

A “large language model” (“LLM”) is an implementation of a machine-learning technique incorporating an attention mechanism. The term language is a reflection of usage in the art; it does not imply any specific size, and is not a term of degree. Thus, many LLMs include billions or even over a trillion trained parameters, but this is not a requirement. Some LLMs disclosed here in can be implemented in a size of about 500 million parameters, or even smaller. Thus, it can be useful to describe “small LLMs” under 20 billion parameters (which can be run on one GPU; often having 100 million to 20 billion parameters), “large LLMs” with over 160 billion parameters (which can be run on a multi-node compute cluster), and mid-sized LLMs from 20-160 billion parameters (which can be run on a single node). While LLMs are often implemented as transformer neural networks, this is not a requirement, and other machine-learning techniques can also be used.

A “large multimodal model” (“LMM”) is a variation of an LLM configured to accept non-text input, e.g. audio or images, instead of or in addition to text. Descriptions of LLMs herein encompass LMMs.

The term “learn” refers to an act of improving performance of a machine-learning tool through training. Learning “X” is short-hand for improving performance on tasks related to X. To illustrate, a machine-learning tool can be trained to learn a language, learn domain-specific knowledge, or learn sensitivity of data.

“Live data” refers to data, accessible to a copilot (for example through a data producer microservice), which is updated independently of the copilot operation. For example, a data producer can have access to an email repository or messaging repository which automatically updates as emails or messages are sent or received. Similarly, staff of an organization can update the organization's databases as part of normal work, and these live databases can be available to a copilot. In contrast to live data, some conventional tools can take periodic snapshots of a live database, and import these snapshots into a copilot environment-such snapshots are not live data. Access to live data allows a copilot to seamlessly provide up-to-date responses to client inputs.

A “loss function” is a function whose value is a distance measure between an output of a machine-learning tool and a corresponding desired response. The value of the loss function can be fed back into the machine-learning tool (e.g. by back-propagation) to update parameters within the tool and improve its subsequent performance.

“Machine learning” (or “ML”) denotes a technique for improving performance of a software tool through experience (dubbed “training”) without additional improvement to (captive) procedural logic of the software tool. A neural network is an example of a software tool that can be trained by machine learning. A trained machine-learning tool can include trained parameters, logic dubbed “captive procedural logic” to perform calculations on input data using the trained parameters to obtain output data, and supervisory program code (dubbed “auxiliary procedural logic”) to manage input and output interfaces, activate the calculations, update trained parameters, collect or provide diagnostic information, or perform other tasks.

A “microservice” is a software implementation of a specific function operating in conjunction with other microservices performing respective functions.

“Mode” refers to a type of data encountered as input or output. Common modes in disclosed copilots include text (including language tokens), speech, other audio, images, video, multimedia. Other modes can include categorical data, numerical data, sensor output, software source code, documents in various formats, database tables, symbol sequences (e.g. for a communication protocol), or various metadata. Internally, a copilot can also support additional modes for communication between microservices, e.g. for task descriptors or signaling. “Multimodal” refers to a software module supporting two or modes of data. In varying examples, a multimodal module can receive input in one mode and provide output in a distinct mode; or can receive inputs in two distinct modes; or can generate outputs in two distinct modes. “Audio” refers to a data mode representing sound in digital form. Thus, audio of two different speakers can differ even when the words spoken are exactly the same. Similarly, “video” refers to a mode in which data is represented as moving visual images. While video recordings can include one or more audio channels, this is not a requirement. Other videos can be silent, or can include captions of verbal communication.

A “neural network” is an artificial network of “units” (or “cells”) that has linkages modeled on behavior of biological neurons and that can be implemented by a software program on a computer. A neural network is an example of a machine-learning tool. Some neural networks described herein can be “transformer neural networks” (or simply “transformers”) which have couplings between cells independent of the spacing between the cells. Transformer neural networks variously use stages labeled “encoder” or “decoder.” Both encoders and decoder stages incorporate an attention mechanism for coupling tokens with each other. Attention in a decoder can be restricted such that generation of a given token can only use (attend to) preceding tokens. In an encoder, generation of a given token can attend to both preceding and following tokens. Empirically, encoders are found to perform well in classification tasks, e.g. by learning word embeddings. Decoders are found to perform well in text generation, e.g. in answering questions. Some LLMs of interest herein combine encoder and decoder stages. An “encoder-decoder transformer neural network” includes one or more (often three to twenty) encoder stages followed by one or more (often three to twenty) decoder stages. Some neural networks described herein can be deep neural networks (“DNN”s) having multiple layers of cells between an input layer and an output layer. Alternatives to LLMs include structured state space models (SSM), and related recurrent neural networks (RNN, a form of DNN) and convolutional neural networks (CNN). State space models implement intermediary latent spaces to maintain state, and can offer similar benefits as attention mechanism in LLMs. For example, such models can be used to implement an expansion microservice or a core microservice. RNNs, decision trees, random forests, or long short-term memory (LSTM) are further examples of trained ML tools which can be used to implement e.g. portions of a core microservice or an evaluation microservice.

A “notification” is a message for which a substantive response may or may not be required. A notification can be presented as a computer communication (e.g. over a bus or network, or written in a shared memory location), as a visual display on a graphical user interface (GUI) or annunciator, or by audio or haptic means. In contrast, a “request” is a message for which a substantive response (e.g. beyond simple acknowledgement) is expected. To illustrate, detection of anomalous behavior can lead to a notification of such behavior and a request for diagnostic or remedial action. The latter request can implicitly perform the notification function.

An “output tolerance” is a maximum variation in output of a machine-learning tool, for specified inputs, that complies with its design or specification. For different modes of output data, the tolerance can be defined numerically, in terms of a similarity score, or in terms of a fraction of outputs that match the desired responses.

A “parameter” is a trainable data object within a machine-learning tool. A “weight” is an example of a parameter in a neural network. Parameters, including weights, are often atomic data, but this is not a requirement. A “composite weight data structure” is a data structure derived from weights or other parameters. It can be an (atomic) weight, or a more complex data type. A “field” is an element of a data structure which can be assigned a value; this value can be an atomic data type or a complex data type.

“Procedural logic” refers to logic operations which can be specified by instructions in a programming language (which can be machine opcodes, assembly instructions, or a high-level programming language, including a hardware description language such as VHDL) and is distinct from data on which those instructions operate. Procedural logic can also be implemented in hardware (e.g. specified by VHDL) by gates coupled to perform operations similar to those of software instructions. Machine-learning tools can incorporate captive procedural logic to process inputs into outputs, and auxiliary procedural logic for auxiliary tasks. Captive or auxiliary procedural logic are particular examples of procedural logic. Procedural logic that is not part of an LLM or other machine-learning tool (e.g. other than captive or auxiliary procedural logic) is sometimes referred to as “freestanding procedural logic” herein.

A “random forest” is an ML tool incorporating multiple decision trees. An input to the random forest can be provided to all the decision trees, and an output from the random forest can be obtained by combination of the decision trees' respective outputs.

The term “receive” refers to an act of getting information at a microservice or other software component from another microservice, software module, or client. Similarly, the term “transmit” refers to an act of conveying information from a microservice or other software component to another microservice, software module, or client. In varying examples, receiving or transmitting can be performed by communication over a bus or network, by message passing (including parameter passing between microservices, e.g. on a call stack), by use of a shared memory location, or by another technique.

In the context of training, a “regimen” is a sequence of training stages, each stage defined by a type (and optionally amount) of training data and a training objective. Two regimens are similar if they have the same sequence of training stages with same types of training data and same training objectives, although the amounts of training data may be different. If the training data are also the same, then the two regimens are identical.

In the context of a threat or attack, “remediation” refers to acts which attempt to reduce or disable any one or more sources, techniques, instances, effects, or other aspects of such threat or attack. Because notifying a victim of a threat, attack, or corresponding compromised data can help the victim perform its own remediation, the term remediation encompasses such notifying.

Within a copilot, a “retrieval microservice” is a microservice whose function is to receive input and provide, as output, documents or other data relevant to that input. The intended audience of output from a retrieval microservice is a core microservice. This core microservice focus does not preclude (i) iterative invocation of the retrieval microservice or (ii) routing of a retrieval microservice's output through other microservices such as qualification or evaluation microservices en route to a core microservice. Moreover, invocation of these other microservices can, in some instances, lead to all or part of the retrieval microservice's output being discarded or otherwise failing to reach a core microservice.

“Sensitive data” refers to data which is confidential or private, e.g. for business or legal reasons. In other contexts, the word “sensitive” by itself can have its plain meaning.

“Similarity” refers to a quantitative measure of likeness between two objects. Illustratively, cosine similarity can be used between vector representations of two tokens or documents, or between a text input and an API query. However, this is not a requirement and other measures can be used. While “similarity” is often used with reference to two like objects, a related term “matching score” can be used to refer to a measure of likeness of semantic content of two objects, which can be of same or different forms. For example, a matching score can indicate whether an API query has semantic content close to a text input provided to a data producer. By way of illustration, the text input and the API query can both be transformed into a vector representation (e.g. a word embedding), and a cosine similarity between these two vector representations can be used as a matching score. In some examples, a data producer can receive non-text input (e.g. audio or image), and a matching score can be generated between such non-text input and a given API query. Another related term “distance measure” refers to a quantitative measure of the difference between two objects having representations in a common space. Distance measure and matching score can be complementary. Thus, two objects having a distance measure of zero are identical; two objects having a small distance measure can be similar or can have a high matching score; and two objects having a large distance measure can be dissimilar or can have a low matching score.

“Software” refers to computer-executable programs or instructions and associated data structures. Software can be in active or quiescent states. In an active state, software can be loaded into memory or undergoing execution by one or more processors. In a quiescent state, software can be stored on computer-readable media, awaiting transmission or execution. Software can be organized in “modules.” Each module can contain one or more functions and associated data directed to a common task or group of related tasks. Any of copilots, microservices, ML tools, LLMs, neural networks, annotations, interview representations, or databases can be implemented as software, which can be organized as respective software modules. Software can evolve over time, and a “snapshot” is a fixed or unchanging copy of the software, or a portion thereof, at a moment in time.

In the context of ML tool deployment, a “target” can be a use case for a deployment (the “target deployment”) of an innovative copilot. A target can be associated with one or more knowledge domains (“target domain”). “Customizing” can refer to configuring (e.g. by training) a copilot to be proficient in the target domain. In the context of disclosed security technologies, a “target” can be an ML tool, a data stream, or other software entity to which such a security technology is applied.

“Text” refers to representations of words (e.g. “microscope”), or printable characters (e.g. “02.03.2024”), which convey semantic meaning.

A “token” is a unit of language, which can be a word, number, phrase, or other representation of semantic content in the language. The language can be a language of human verbal communication, but that is not a requirement. To illustrate, in a visual language of art or graphics, a red rectangle or a face can be a token. A token of a human communication language (e.g. English) can be represented as text, audio, image, or in another mode. To illustrate, a red patch in an image can represent “red.” Commonly, closeness between two vector representations can be an indication of closeness of their underlying semantic content.

A “vector representation” is a representation of a language token in a multi-dimensional space. Word embedding techniques can be used to obtain vector representations of language tokens.

### Training

Training of a machine-learning tool such as an LLM can be performed in stages. Generally, a unit of training data inputted to the tool during training can have a desired output, known as a “desired response.” Training data can also be annotated. The annotation is known as a “label.” In some examples, a label can be the desired response while, in other examples, the label can be a hint that assists the machine-learning tool in classifying or otherwise processing the unit of training data without specifically being the desired response.

“Pretraining” stages can be performed without explicitly labeling data or providing any desired response. Rather, the desired response can be automatically extracted from inputted training data. To illustrate, a pretraining stage can train a tool to perform a masked language modeling (MLM) task, e.g. recovering a data erasure. Thus, given an input “the car is blue”, a pretraining phase can automatically erase a word from the input and use the erased word as the desired output. Thus, the tool can be trained, inter alia, to respond with “car” for MLM input “the * is blue”. Other tasks can be similarly used for pretraining. In a next word prediction task (“prefix LM”), the tool can be trained to respond with “blue” for input “the car is”. Training data used for pretraining can be in the form of complete documents or a corpus of multiple documents.

“Fine-tuning” refers to one or more optional additional training stages that can be performed to customize a machine-learning tool (e.g. a neural network, LLM, microservice, or copilot) for a particular target deployment or to update the tool subsequent to initial deployment. Training data used for fine-tuning can be organized as records, each having a “training input” which is to be provided as input to the tool and a “desired response” (e.g. a label) against which output of the tool can be measured. However, this is not a requirement, and fine-tuning can also be implemented using similar (unlabeled) data and tasks as a pretraining stage. Fine-tuning can be generic, e.g. training a tool to perform a particular task in a domain-independent fashion, or can be targeted to a specific knowledge domain.

Any training stage can improve or optimize performance on a given task. In addition to MLM and prefix LM, non-limiting examples of common training tasks include question-answering (multiple choice or closed-book), sentence completion, sentiment analysis, word sense disambiguation, coreference resolution, or natural language inference (e.g. determining whether an inputted hypothesis is true, false, or indeterminate).

A trained tool can provide output that matches or is similar to the desired response on at least a predetermined fraction of test inputs. To illustrate, a training input can be “what color is the car?” and the desired response can be “blue.”

Training records can be created in various ways. In some examples, both training input and desired response can be created by a human expert. In other examples, a software tool can extract training inputs (e.g. questions) or desired responses (e.g. answers) from a document or corpus of documents, and a human expert can provide complementary desired responses or training inputs. In further examples, a software tool can generate both training inputs and desired responses, in which case the training data is said to be “synthesized.” The software tool can be an LLM based tool, but this is not a requirement, and other question and/or answer generating tools can be used. In examples, synthesized training data can be screened by a human expert, often with considerably less effort than required to generate the desired responses or the training inputs without assistance.

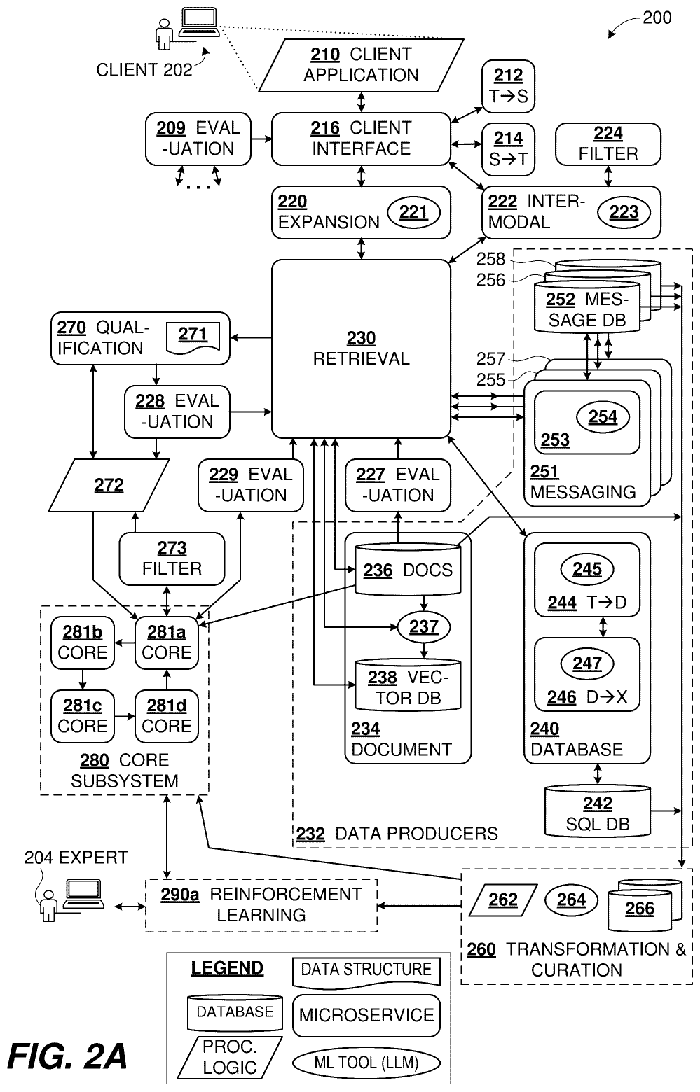

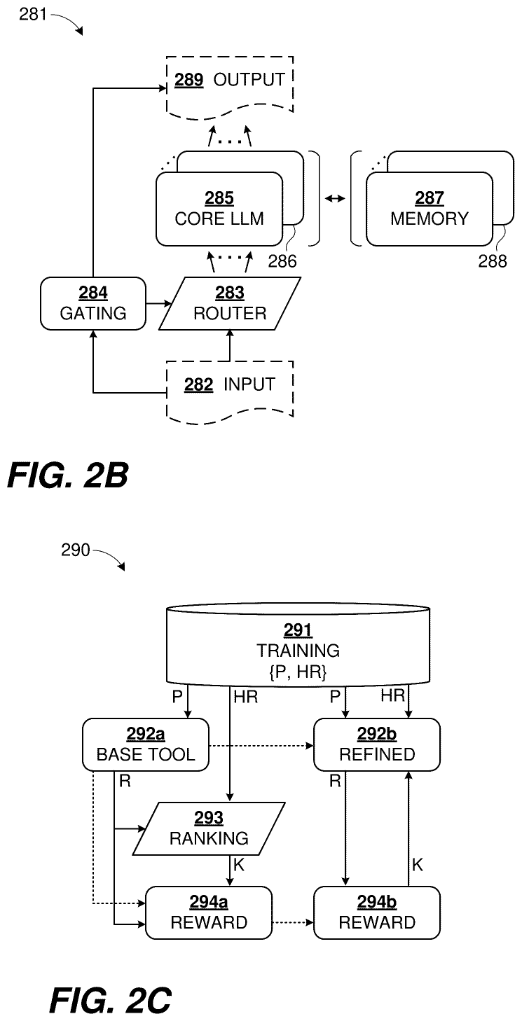

Training can be performed at multiple levels, e.g. on a single LLM or machine-learning tool; individually for each LLM in a mixture-of-experts or ensemble of LLMs; collectively on the mixture-of-experts or ensemble; on a group of microservices such as a retrieval microservice and one or more associated data producers; or on a complete copilot similar to that illustrated in FIGS. 2A-2B. Commonly, training can be performed bottom-up, starting with smaller tools and proceeding to successively larger tools, but this is not a requirement. Particularly fine-tuning updates can be performed on one or a few microservices without necessitating additional training of larger units or an entire copilot.

In examples, some domain-specific pretraining or fine-tuning stages can be customized to particular levels of client authorization, leading to variants of a given trained microservice.

A copilot can incorporate a capability to trace dataflow and internal data as the copilot acts on a given client input. Such a tracing capability can assist in determining performance levels of various microservices and lead to focused fine-tuning of an underperforming microservice. The disclosed microservice architecture lends itself to debugging or continual improvement in this manner because the internal data passed between microservices can be intelligible to a human analyst. In a competing large LLM approach, while activations can in principle be traced, no systematic approach is available for using such activations to identify focus areas for remedial training. Any microservice can be instrumented with an API allowing restricted access by developers to monitor performance, adjust configuration of the microservice, or apply additional training.

As described further herein, some attacks can attempt to corrupt operation of an ML tool by poisoning training data. Such attacks can occur at any training stage. Some disclosed techniques can be used to monitor streams of training data and detect anomalies.

Other disclosed techniques can treat an input data stream to tool ML1 as a training data stream for tool ML2. In this way, the common data stream, which may not change any parameters of ML1, can cause measurable changes in ML2, which can be reflected in a fingerprint of ML2, allowing prompt engineering or other adversarial attacks to be detected.

### Microservice Network Architecture—Overview

FIGS. 2A-2C illustrate a microservice network architecture with which some disclosed technologies can be implemented. The microservice architecture can provide efficient implementations of customized copilots, with low compute requirements, for a wide range of applications. While not limited to such architecture, the disclosed technologies can enhance security of microservice network tools, including those incorporating large language models or comparable ML tools. This section and the next provide an overview of a class of copilots implemented with a microservice network architecture.

### 1. Size and its Disadvantages

Comparative tools are very large, often having several hundred billion parameters or more. But, size comes with penalties. For an LLM with N trainable parameters, the computational burden to process a given input into output (e.g. perform an inference) can scale as O (N). Furthermore, the computation burden (e.g. in flops) of training an LLM can scale as O (N·D), where D is an amount of training data. While D can be chosen independently of N, larger models often require more training data than small models. Illustratively, in some examples, D can also scale as O (N), meaning that the computation burden of training an LLM can scale as O (N²). Other types of ML tools can exhibit similarly unfavorable scaling.

Additionally, computer systems of greater complexity can be required to support large LLMs. A common architecture is based on a compute node incorporating a general purpose processor (so-called “CPU,” for central processing unit) with one or more accelerators or coprocessors (“GPU”), which support parallel operations and are often graphical processing units. Multiple nodes can be coupled to form a “compute cluster.”

As currently deployed, one GPU can support up to about 20 billion parameters, and one CPU can support about eight GPUs. Thus, known LLMs with 200 billion to 2 trillion parameters can require compute clusters with two to about thirteen nodes. Because transformers have long-range connectivity across neurons and layers, the performance of progressively larger LLMs can worsen discontinuously going from a one-GPU system, where passing data is local, to a multiple-GPU system, and again from a one-node system to a multiple-node system. That is, total computation time can be dominated by the time required for data communication rather than for compute operations. For these reasons, computation time can be worse, by a factor of 10 or more, than that predicted by O (N) scaling for inference or O (N·D) scaling for training.

### 2. Microservice Network Architecture and its Advantages

Some architectures disclosed herein utilize a coupled network of microservices, variously implemented as LLMs, other machine-learning tools, or procedural logic—the latter including rule-based or other program logic. Some examples of the disclosed technology incorporate numerous small LLMs (which can be run on one GPU), and one or a few mid-sized LLMs (which can be run on one node). While the description herein often refers to LLMs for reasons of current popularity and clarity of illustration, the disclosed innovations are not so limited. Many of the LLM implementations disclosed herein can be substituted by other trained ML tools. That is, descriptions of LLMs herein generally extend to other trained ML tools, in addition to LLMs.

A microservice network architecture has been found to exhibit emergent behavior and can provide performance comparable to competing trillion parameter models on some tasks for which it is designed. In one view, the microservice network as a whole can be greater than the sum of its parts-having cognitive functioning capabilities arising from the network organization of its constituent parts which are absent in any of those constituent parts.

At the same time, the microservice network copilot can provide significant benefits, as described further herein.

Reduced training time: Relative to a 1 trillion parameter competing product, the computational burden to train a disclosed 70 billion parameter core microservice is reduced by a factor of 200 (based on O (N²) scaling) to 2,000 (also accounting 10× for eliminated inter-node data communication overhead) or more.

Reduced inference time: Relative to a 1 trillion parameter competing product, the computational burden to train a disclosed 70 billion parameter core microservice is reduced by a factor of 15 (based on O (N) scaling) to 150 (also accounting 10× for eliminated inter-node data communication overhead) or more.

Improved performance of specialized functions: Decoupling specialized functions into respective microservices allows each microservice to be optimized and to perform that specific function better and more efficiently than a general-purpose large LLM for which the specific function is merely a small part of its overall functioning. As an analogy, a pen is suitable for writing a signature and a paint sprayer is suitable for painting a house. Just as it is difficult for one tool to do both signatures and house-painting, it can be difficult or inefficient for one large LLM to be effective at multiple specialized functions.

Administrative independence: Each microservice can be trained and maintained independently of other microservices, e.g. at different times, or on different computing environments. However, additional training of the assembled microservice network is not precluded.

Sequential operation: Because microservices can interact at the application programming interface (API) level, the microservices can be efficiently run sequentially on a small computer system, rather than requiring multiple microservices to run concurrently. However, parallel operation is not precluded, e.g. to support pipeline operation with multiple clients or to reduce latency.

Ease of modification: Individual microservices can be attached, detached, updated, or fine-tuned without having to re-train a large LLM.

Ease of customization: Because individual microservices can be trained in hours (e.g. less than one day; or sometimes even less than one hour), rather than months, it can be feasible to develop customized copilots for various applications. Various types of customization can be performed. In varying examples, customization can be performed for knowledge domain, training datasets, accessible data repositories, cognitive functions, supported tasks, modes of client input, levels of client authorization, perspective on the knowledge domain, or alignment goals.

Safety-bias, toxicity, or hallucination: Small LLMs can be safer than large LLMs, e.g. less prone to bias and toxicity. Moreover, a microservice network architecture allows safety mechanisms, such as bias and toxicity filtering, to be incorporated at specific positions in the network architecture to mitigate such undesirable artifacts at, or immediately following, the point or points where these artifacts may be introduced. In this way, filtering can be applied in a manner analogous to a local anesthetic at the point(s) of greatest need. In contrast, competitive large LLMs can require artifacts to be monitored and corrected from the outside, akin to a general anesthetic, applied indiscriminately. Still further, addressing artifacts in a competing large LLM can involve retraining, which can counteract the primary training of the large LLM, adversely affecting its performance for its intended purpose.

Another artifact, hallucination, refers to generation of erroneous answers (sometimes passing off fiction as fact). This can be difficult to detect, let alone correct, in the black-box architecture of competing large LLMs. In contrast, some examples of the disclosed microservice architecture introduce a qualification microservice to detect whether a client input lies within the competency of the microservice network. Particularly, this can be invoked effectively after client input has been digested and the projection of the client input onto the available knowledge corpus is known, but before e.g. any core microservice has acted to produce a client output. In contrast, a competing large LLM can be constrained to examine (i) raw client input, whose relationship to a knowledge corpus may not be well known or (ii) client output, which by design reflects an underlying knowledge corpus, and from which competency cannot be readily ascertained.

The inventors have tested an embodiment (dubbed “Thia”) of the disclosed technologies. A set of test inputs (combined documents and text queries) was formulated by subject-matter experts in the aerospace domain, and the inventors verified that the test inputs or essentially similar inputs were not included in any training data of the underlying models. The test inputs were provided to (i) a version of Thia that was embedded in a corporate data environment, and to (ii) a comparative large LLM (GPT-4) having access to documents from the same data environment. Human evaluators were used to provide blind ratings of the outputs of Thia and GPT-4 for each input, along with qualitative feedback on what characteristics of the higher-ranked and lower-ranked output led to the ranking. In these tests, human evaluators ranked Thia outputs higher than GPT-4 outputs in over 93% of the test cases.

### 3. Copilot Applications

Various terms have gained popularity for LLM-based tools providing assistive language interfaces, including “agent,” “assistant,” “chatbot,” or “copilot.” In the art, each of these terms has seen varying usage to refer to tools having widely disparate capabilities. In this disclosure, the term “copilot” is used broadly for a software tool providing knowledge-based assistance to a user in the furtherance of some task. Thus, the scope of the term copilot encompasses, without limitation, question-answering systems, generative tools (e.g. new text, audio, video, or art), interfaces to machinery, education delivery, language translation, or other tasks. Some copilots can support one or more of these applications. Additionally or alternatively, a copilot can support other applications.

In some examples, a copilot can provide a conversational interface and can use LLMs or other language models to support interaction with a client, interaction with data repositories, or for other specialized functions. Copilots can interpret a client's input, analyze data, unify multiple sources of information, make decisions, and provide context-aware output.

A copilot can be specialized for specific tasks, specific knowledge corpora, or specific cognitive functions. The copilot can be trained to perform those specific tasks, with those knowledge corpora, or with those cognitive functions.

Some copilots can provide read-only access to data, but this is not a requirement and, in other examples, a copilot can be used to modify, update, or delete data responsive to client input.

Copilots can be deployed by enterprises (e.g. for internal use, or for use by customers or other partner organizations), in vehicles (e.g. automobiles, aircraft, ships, submarines, or spacecraft), by individuals (e.g. trained for personal finance or household automation, or as online avatars), or in other roles (e.g. air traffic control, monitoring physical sensors or communication networks for security or surveillance).

A customized copilot can consolidate diverse databases or stores of knowledge within an organization, reducing the problems often encountered in having information available where and when needed. At the same time, examples of the disclosed technologies can honor security protocols and maintain, by design, restricted access to sensitive data.

### Microservice Network Architecture—Components

FIG. 2A is a schematic diagram 200 of an example architecture of a copilot to which the disclosed technologies can be applied. Shown in FIG. 2A is a network of modules implementing respective microservices, with arrows showing some possible communication paths among the microservices. This architecture is exemplary. Any given embodiment can omit certain modules or paths, incorporate other modules of paths, or implement other variations. The illustrated microservice network can be configured to implement a copilot serving one or more client applications, with capabilities for certain tasks comparable to or exceeding those of much larger, slower, and power-hungry competitive architectures. FIGS. 2B-2C are insets providing a detailed view 281 of a core microservice 281a-281d and a detailed view 290 of reinforcement learning subsystem 290a respectively. A legend in FIG. 2A shows the shapes used for microservices, databases, other data structures, procedural logic (“Proc. Logic”), and trained ML tools (some of which can be LLMs). As described further herein, additional or different entities can be implemented. In varying examples, certain microservices within which an ML tool is shown may also include procedural code which is not shown; procedural logic can be substituted for a depicted microservice; or more than one microservice or ML tool can be implemented where one is shown. For conciseness of illustration, short-hand labels are used in FIGS. 2A-2C.

Each microservice operates by receiving input, performing a specialized function on that input to obtain an output, and transmitting that output. The microservices can variously operate based on an LLM, on another trained machine-learning tool, or on freestanding procedural program logic. Input can be received from a source such as another microservice or a client. Output can be transmitted to a destination such as another microservice or a client. Client application 210 can be run on computing hardware of client 202.

In some instances, a microservice can transmit output to the source from which it received input. In other instances, the microservice can transmit output to a destination different from the source. In further instances, the microservice can transmit multiple outputs to respective destinations, one of which can be the source. To illustrate, invocation of microservice A can initially invoke another microservice B, meaning that A transmits a first output to B. Later, when microservice B and perhaps other microservices have completed and transmitted their outputs eventually reaching A, microservice A can transmit another output responding to its source.

A microservice can invoke none, one, or more than one, microservice. In varying examples, a microservice can perform its specialized function upon receipt of inputs from one, two, or more distinct sources.

In some examples, microservice invocations can be stacked, as in a software call stack, so that as each microservice completes, control returns to its caller (source), but this is not a requirement. In other examples, event-driven or non-blocking paradigms can be used. Microservice A can invoke microservice B and can terminate, or continue, without waiting for microservice B to complete. In further examples, a mix of these or other types of flow control can be used.

Among other microservices, FIG. 2A illustrates expansion microservice 220, retrieval microservice 230, core microservices 281a-281d, and evaluation microservices 209 and 227-229.

Because a backdoor attack can corrupt any microservice or ML tool, disclosed fingerprint techniques (similar to 175, 176 of FIG. 1) can be applied to any ML tool illustrated in FIGS. 2A-2C. A baseline fingerprint of an ML tool can be stored, and a current fingerprint can be computed multiple times over the lifetime of the tool's deployment to detect corruption of the tool.

Because ML tools within a microservice architecture can be trained prior to deployment, and fine-tuned further over the course of deployment, disclosed techniques to monitor a training data stream (e.g. through calculation and monitoring of a fingerprint, to detect data poisoning, similar to 177, 178) can also be applied to any ML tool illustrated in FIGS. 2A-2C.

Because the disclosed security technologies can be so widely applied with the architecture of FIGS. 2A-2C, and for clarity of illustration, instances of these security provisions are not expressly shown in FIGS. 2A-2C.

### 1. Expansion Microservice and ML Tool

Expansion microservice 220 can be configured to receive first input incorporating one or more language tokens, e.g. derived from a client input, and determine one or more substitute or additional tokens associated with the received language tokens. To illustrate, an input token “lunch” can variously spawn additional tokens such as “time,” “calendar,” “break,” “policy,” “restaurant,” or “recipe,” any of which could be relevant to the client's intent, albeit absent in the client's actual input. Expansion microservice 220 can incorporate or be coupled to trained ML tool (“expansion tool”) 221, which can be an LLM.

Separating expansion tool 221 from other ML tools or microservices in the copilot architecture enables efficient training of a small ML tool for the expansion function, which can be easily customized or fine-tuned for a particular deployment. To illustrate, “calendar” could be an important token in one deployment, but irrelevant in another deployment. Customized training of tool 221 enables a copilot deployment according to the disclosed technologies to produce high quality output with less computational effort than competing architectures.

Moreover, removing the burden of tool 221's functionality from other microservices in the copilot architecture enables those microservices to be implemented more compactly and efficiently as well.

Numerous variations and extensions can be implemented within scope of the disclosed technologies. In varying examples, expansion microservice can perform expansion variants such as standardizing word forms (e.g. “ran,” “running”> “run”), replacing synonyms (“fine,” “excellent”) with standard terms (“good”), splitting (“lunchtime”> “lunch” and “time”). Alternatively, each of these variants can be performed by separate microservices, in any combination.

In examples, expansion microservice 220 can transform a user's query into smaller, more specific questions. Expansion microservice 220 can convert user inputs into well-formatted and targeted tasks to be delivered to core microservice 281a.

Expansion tool 221 can be constructed from an encoder-decoder transformer based neural network. Flan-UL2 is an example of a suitable base transformer neural network.

### 2. Intermodal Microservice and LMM

Some examples of the disclosed technologies can implement intermodal microservice 222 to support modes of client input other than text.

Intermodal microservice 222 can be configured to receive second input, which can be derived from client input and can contain one or more tokens, which can be audio inputs, images, or video. Intermodal microservice 222 can determine one or more language tokens from the second input, for example using an intermodal LMM 223. A second output comprising these language tokens can be transmitted.

Numerous variations and extensions can be implemented within scope of the disclosed technologies. In some examples, client input can contain non-text data and intermodal microservice 222 can be invoked from client interface microservice 216. Second output from microservice 222 can be returned to client interface microservice 216 to be forwarded to expansion microservice 220. In other examples, non-text data objects can be encountered during retrieval augmented generation (RAG) by retrieval microservice 230, and intermodal microservice 222 can be invoked from retrieval microservice 230. In such instances, language tokens (second output) can be returned to retrieval microservice 230, or can be conveyed to expansion microservice 220 for expansion just like any text-mode input. Other connectivity between intermodal microservice 222 and data producers or core microservices can also be provided. Multiple intermodal microservices 222 or multiple intermodal LLMs 223 can be provided, e.g. for respective classes of non-text data.

Similarly, other intermodal services can be implemented to generate client output in modes other than text for some applications. To illustrate, speech output can be beneficial in e.g. automotive, mobile, or public-announcement applications where a user's visual attention may be occupied or where a visual display is not available. Non-text visual outputs can be beneficial for e.g. status or alarm notifications, charts, diagrams, or other visualizations.

Thus, intermodal microservices 222 can process visual, audio, or text data, enabling a copilot to interpret audio or visual input as text, or generate audio or visual output from text.

In some examples, intermodal microservices 222 can handle all non-text input. In other examples, specialized client-side microservices 212, 214 can be implemented. As shown in FIG. 2A, speech-to-text service 214 (“S->T”) can process client speech to provide text from client interface 216 to the copilot. Conversely, text-to-speech service 212 (“T->S”) can process text outputted to client interface 216 into speech.

Supporting multiple input or output modes in a competing large LLM can be a significant burden, Removing the burden of LLM 223's functionality from other microservices enables those microservices to be implemented much more compactly and efficiently.

Moreover, and similar to expansion microservice 220 or expansion LLM 221, separating intermodal microservice 222 from other microservices or LLMs enables efficient implementation and training of an intermodal conversion function, which can be easily customized or fine-tuned for a particular deployment. To illustrate, two intermodal LMMs 223 can be trained for respective speakers' voice or vocabulary, while another intermodal microservice can be trained to generate a particular type of visual output without wasting effort on other types of output that may not be required in a particular application. Customized training of intermodal LLM such as 223 enables a copilot deployment according to the disclosed technologies to produce high quality input or output conversion with less computational effort than competing architectures.

### 3. Retrieval Microservice and RAG

Retrieval microservice 230 can be configured to receive third input, which can include or be based on output from expansion microservice 220 or intermodal microservice 222. Retrieval microservice 230 can perform a function of retrieving data relevant to the third input. Retrieval microservice 230 can perform this function by invoking other microservices dubbed “data producers” (collectively 232), examples of which are described further herein. The retrieved data can be used to augment the received third input, thereby facilitating still other microservices such as core microservices, described further herein, to efficiently generate high-quality outputs for respective inputs (e.g. the third input), which ultimately derive from an original client input. The generation of augmented input by data retrieval is termed “retrieval augmented generation” herein.

Accordingly, retrieval microservice 230 can retrieve one or more data objects related to the third input from one or more of data producers 232, and can use these data objects to augment the third input so as to obtain fourth output, which can be transmitted toward one or more of the core microservices.

Numerous variations and extensions can be implemented within scope of the disclosed technologies. In examples, retrieval microservice 230 can be further configured to repeat the RAG, based in part on the retrieved data objects or further successively retrieved data objects, until a termination condition is met. An evaluation microservice, similar to 227 or 228 and as described further herein, can be invoked to assist in making the determination whether to further iterate the RAG.

In some instances, the evaluation microservice can determine that one or more of the retrieved data objects are sufficient to accurately respond to the third input, and no invocation of core microservices 280 is required. To illustrate, a client input can be directed to finding what time a plane flight departs. The answer to this question could be contained in a retrieved document or database object. In such case, a response to the third input can be returned toward the client directly from the evaluation microservice or retrieval microservice 230.

In examples having a plurality of data producers 232, retrieval microservice 230 can determine which data producer(s) (e.g. 234, 240, 251, 255, 257) to invoke for retrieval of data objects. Successive RAG iterations can invoke different data producers 232. For example, data objects retrieved from messaging microservice 251 can be used to perform RAG using database microservice 240, or vice versa. Data objects retrieved from messaging microservice 251 or database microservice 240 can be used to perform RAG using vector index 238 of document repository 236, or vice versa.

In varying examples, retrieval microservice 230 can be implemented with an LLM, another trained ML tool, or freestanding procedural logic, in any combination.

In some examples, retrieval microservice 230 can vectorize received input (e.g. third input or retrieved data objects) and can search various databases to retrieve relevant data objects. The data retrieved from these databases can be passed to a core microservice to provide context and domain information to assist in efficiently determining accurate output for the third input. As described herein, retrieval microservice 230 can invoke additional microservices to assist with its tasks.

### 4. Data Producer Microservices

Examples of the disclosed technologies can utilize a wide range of data repositories for RAG. Microservices 234, 240, 251, 255, 257 supporting retrieval of relevant data objects from these repositories are dubbed “data producers” (collectively 232) herein. The next few sections describe exemplary data producers 232, which also include generic data producer 257.

The repositories available to the data producers 232 can have zero overlap with, partial overlap with, or can be identical to, data used to train e.g. core microservices 281a-281d described herein. In examples, RAG can enable a core microservice 281 to reach beyond its training in generating outputs relevant to a client input. Moreover, these repositories and their associated microservices can be maintained and updated independently of core microservices 281a-281d, enabling capabilities of a copilot to advance without any fine-tuning or supplemental training of core microservices 281a-281d.

Inasmuch as core microservices 281a-281d can implement LLM variants tailored to respective levels of client authorization, data repositories accessed by data producers 232 or retrieval microservice 230 can also be segregated or nested into variants according to the levels of client authorization.

### 5. Embedding Microservice and Document Microservice

Some examples of the disclosed technology can use vector embedding to find relevant documents in a vector-indexed document repository. That is, retrieval microservice 230 can invoke embedding microservice 237 to determine relevant vector word embeddings. A document microservice 234 can be used to map these word embeddings to relevant documents using a vector index 238, and the identified documents can be retrieved from the document repository 236.

Embedding microservice 237 can be invoked on fifth input, from retrieval microservice 230, which can be based on the third input (e.g. on a first RAG iteration), or on subsequently retrieved data objects (e.g. on a subsequent RAG iteration). Upon receipt of the fifth input, embedding microservice 237 can determine and transmit, as fifth output, one or more vector embeddings representative of at least portions of the fifth input.

Document microservice 234 can be invoked on sixth input, which can include or be based on the fifth output. Upon receipt of the sixth input, document microservice 234 can identify and transmit one or more documents having content similar to at least portions of the sixth input.

Numerous variations and extensions can be implemented within scope of the disclosed technologies. In some examples, document microservice 234 can be invoked from embedding microservice 237 while, in other examples, vector embeddings can be returned from embedding microservice 237 to retrieval microservice 230. In further examples, the vector embeddings can be provided to core microservices that have been trained on vector embeddings, or can be provided to other data producers 232 which also maintain respective vector indexes.

In varying examples, embedding microservice 237 can be implemented with an LLM, another trained ML tool, or program logic, in any combination.

Documents can be encoded in terms of dense vectors to create searchable vector databases 238. In examples, document microservice 234 can be constructed using a sentence transformer LLM configured to convert sentences of the document into 768-dimensional dense vectors. Such an LLM can group similar documents into a common document cluster and can support semantic search.

### 6. Database Microservices

Some examples of the disclosed technology can use a database microservice to find relevant data objects stored in one or more databases. Exemplary databases can be relational or other table-oriented databases. The databases can be SQL databases or no-SQL databases. A wide range of databases can be integrated into the disclosed copilot architecture. The returned data objects can be used for RAG by retrieval microservice 230.

Database microservice 240 can be invoked on seventh input, from retrieval microservice 230, which can include or be based on the third input (e.g. on a first RAG iteration), or on subsequently retrieved data objects (e.g. on a subsequent RAG iteration). Upon receipt of the seventh input, database microservice 240 can retrieve database objects relevant to the seventh input from one or more databases 242. Database microservice 240 can determine and transmit a seventh output including or based on the retrieved database objects.

Numerous variations and extensions can be implemented within scope of the disclosed technologies. A database indexing microservice can be configured to generate or maintain at least one index from the one or more databases. Retrieval of the database objects can be efficiently performed using the at least one index. In some example, each database 242 available to database microservice 240 can have its own distinct index while, in other examples, a common index can be maintained across multiple databases 242. In varying examples, a copilot architecture can implement a plurality of database microservices, each supporting one or more respective databases or database types.

In some examples, data objects returned can be returned in a form similar to that stored in the databases. To illustrate, a data object can be returned as the value of an individual field in a database table, which can be an atomic datatype such as a string or number, a data structure, a document stored in that field, or a link to any of these. As another illustration, a data object can be returned as a record (e.g. a row of a database table), a column, or other subset of a database table or view. The returned data objects can further include identifiers of the database, table, records, or columns where they are stored, or other indicators enabling providing traceability of the data objects.

In other examples, database microservice 240 can process retrieved data objects to return seventh output in the form of a document. Such processing can include text formatting, conversion of non-text database objects to text, generation of sentence- or paragraph-style text, or charts providing graphical visualization of the retrieved database objects.

In some examples, database microservice 240 can invoke a text-to-SQL microservice 244. Text-to-SQL microservice 244 (“T->D”) can translate part or all of the seventh input (e.g. questions generated by expansion model 220) into one or more SQL queries. These queries can be used to retrieve the database objects from an SQL database in real-time. In some examples, microservice 244 can obtain an SQL query by scoring a library of SQL queries against the text input, similar to the method of FIG. 7 herein. In other examples, text-to-SQL microservice 244 can utilize LLM 245, which can be constructed based on instruction-tuning an LLM such as Mistral-7b on a mixture of proprietary and open-sourced datasets.

In some examples, database microservice 240 can invoke a table-to-X microservice 246 (“D->X”), where X can be text (“T”) or another mode. Microservice 246 can generate textual statements based on data or tokens extracted from retrieved tabular database data objects. Microservice 246 can utilize LLM 247, which can be constructed based on a GPT-type model trained for generation of coherent natural language responses from a database table, fine-tuned with domain specific datasets. In variations, LLM 245 or 247 can be implemented as another type of trained ML tool.

Microservices 244, 246 can also communicate with each other as shown, for feedback or evaluation. To illustrate, database data producer microservice 240 can implement an internal evaluation module, to determine whether the X output of microservice 246 is an appropriate response to the T input received by microservice 244.

### 7. Messaging Microservices

Some examples of the disclosed technology can use a messaging microservice to find relevant message objects (e.g. messages or metadata) stored in one or more message repositories. Exemplary message repositories can store email, voicemail, text messages (e.g. compliant with Short Message Service, known as “SMS”), instant messages, video messages, multi-mode messages, or attachments thereto, along with corresponding metadata. A wide range of message types or messaging applications can be supported. Returned message objects can be used for RAG by retrieval microservice 230.

The content of a message repositories can share some attributes of database tables and some attributes of documents and, accordingly, messaging microservices can be implemented separately from a document microservice or a database microservice. Various message repositories can have similarities with each other. Below, messaging microservice 251 for emails is described. FIG. 2A also shows messaging microservice 255 which supports Slack® messages. Slack® microservice 255 and generic data producer microservice 257 can provide access to repositories 256, 258 respectively. Features and operation of microservice 255 can be similar to those of microservice 240 or 251, and are not described further.

Messaging microservice 251 supports email and is described further. Messaging microservice 251 can be invoked on eighth input, from retrieval microservice 230, which can include or be based on the third input (e.g. on a first RAG iteration), or on subsequently retrieved data objects (e.g. on a subsequent RAG iteration). Upon receipt of the eighth input, messaging microservice 251 can retrieve message objects relevant to the eighth input from one or more message repositories 252. Messaging microservice 251 can determine and transmit an eighth output including or based on the retrieved message objects.

Numerous variations and extensions can be implemented within scope of the disclosed technologies. A message indexing microservice can be configured to generate or maintain at least one index from the one or more message repositories 252. Retrieval of the message objects can be efficiently performed using the at least one index. In some examples, each message repository 252 available to messaging microservice 251 can have its own distinct index while, in other examples, a common index can be maintained across multiple message repositories 252.

In some examples, messaging microservice 251 can invoke a query adaptation microservice 253. Query adaptation microservice 253 can translate part or all of the eighth input (e.g. questions generated by expansion model 220) into one or more queries targeting message repository 252. These queries can be used to retrieve the message objects from message repositories 252 in real-time. Query adaptation microservice 253 can utilize LLM 254, which can be constructed based on similar principles as LLM 245.

In varying examples, a copilot architecture can implement a plurality of messaging microservices, each supporting one or more respective message types or messaging applications.

### 8. Qualification Microservice

Some examples of the disclosed technologies can implement e.g. qualification microservice 270 to qualify inputs in relation to the competencies of the copilot. The disclosed microservice architecture allows qualification to be determined deep inside the copilot at one or more selected points in the processing flow. This can save processing effort in cases of copilot incompetence. Additionally, qualification microservice 270 can operate input-side, e.g. before inputs have reached core microservices subsystem 280, which can provide precise comparison of a client input with copilot competency.

In contrast, conventional tools, particularly those intended as general-purpose tools, can be limited to determining competency from the outside, either directly from the client input, when the scope of the client input is not well-known, or from the client output, when evaluation can be confounded by output that looks good. For these reasons, conventional tools often do not even attempt to determine competency, greatly increasing the risk of hallucination or other artifacts.

Qualification microservice 270 can be configured to receive ninth input, which can include or be derived from fourth output produced by retrieval microservice 230. Qualification microservice 270 can compare all or part of the ninth input with graphical model 271 of a knowledge corpus incorporated in the copilot, to determine whether the copilot is competent to act on the ninth input.

In some examples, graphical model 271 can be a map in a multi-dimensional vector space similar to that used by embedding microservice 237 or vector index 238. The map can define one or more surfaces or envelopes separating interior regions of the vector space which are within scope of the knowledge corpus from exterior regions which are outside the scope of the knowledge corpus. Thus, the copilot can be determined to be competent for portions of the ninth input that map to an interior region, and can be determined to be incompetent for portions of the ninth input that map to an exterior region.

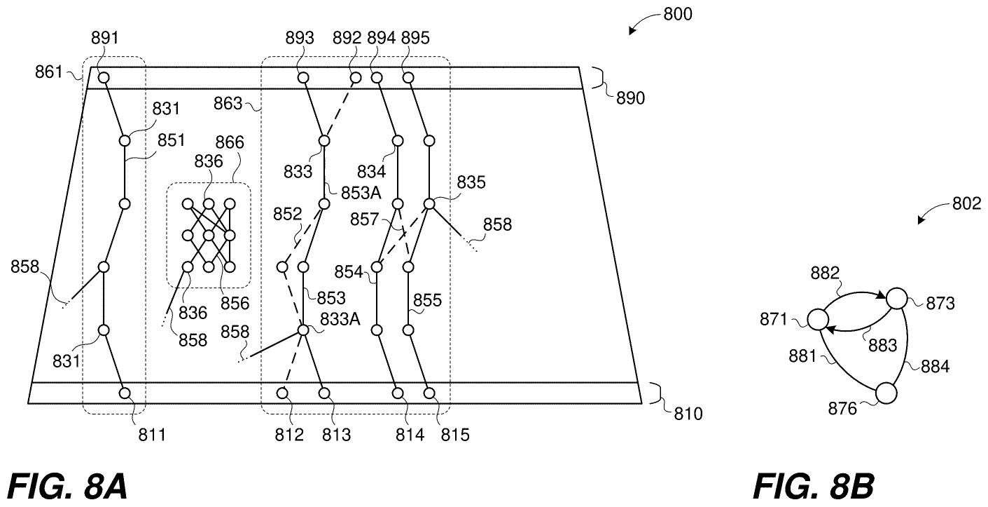

In some examples, the knowledge corpus represented by graphical model 271 can include one or more datasets on which core microservices or other microservices of the copilot have been trained. In other examples, the knowledge corpus can include databases available to any data producer from which RAG can be performed. Graphical model 271 can be pruned as described in context of FIG. 8 herein.

In some examples, a determination of competence can require that all portions of the ninth input map to interior regions while, in other examples, competence can be determined on a portion-by-portion basis. In such case, a determination of incompetence can require that all portions of the ninth input map to exterior regions. Otherwise, the portions of the ninth input mapping to exterior regions can be discarded, the copilot can be deemed competent for the remaining portions of the ninth input, which map to interior regions, and processing can proceed.

In either case, upon determining that the copilot is competent, qualification microservice 290 can determine and transmit ninth output, including or based on the ninth input, toward at least one of the core microservices. Alternatively, upon determining that the copilot is not competent, qualification microservice 271 can transmit a notification indicating lack of competence, e.g. back to retrieval microservice 230, or directly back to client interface microservice 216.

Numerous variations and extensions can be implemented within scope of the disclosed technologies. The placement of qualification microservice 270 is exemplary, and alternative or additional qualification microservices can be placed elsewhere. For example, a qualification microservice can be placed within each data producer, with a scope of competence limited to the stored data of that data producer.

### 9. Core Prompting Module

In some examples, inputs to core subsystem 280 can be managed by core prompting module 272. Output from qualification microservice 270 can be split or organized into one or more prompts provided to core microservice 281a. In some examples, the path from qualification microservice 270 to module 272 can be mediated by evaluation microservice 228, so that some outputs from qualification microservice 270 can be forwarded to module 272, while others can lead to another invocation of retrieval microservice 230.

Module 272 can also be invoked based on output from filter 273, e.g. to release additional prompts queued at module 272, or to blacklist certain prompts leading to unacceptable output from core subsystem 280.

### 10. Core Microservice

With various stages of input-side processing described above, inputs can reach a core microservice such as microservice 281a. Core microservice 281a and other core microservices 281b-181d can incorporate LLMs (or other trained ML tools) trained to perform general or specific respond-to-input tasks within one or more domains of interest. Thus, in some examples a core microservice in the disclosed architecture can be used to implement a general-purpose copilot similar to presently popular chatbots, albeit with a much smaller total size and much lower computational demands. In other examples, a core microservice can be trained for particular specialized tasks or for specialized knowledge domains. Non-limiting examples of specialized tasks include question-answering, generative tasks (e.g. software code, text, or art), natural language interfaces to a database, causal reasoning, literature search (e.g. scientific, legal, journalistic, or in the humanities), or education (e.g. tutoring, grading). Non-limiting examples of specialized knowledge domains include public or private databases (e.g. scientific, legal, journalism, humanities, linguistic, corporate, enterprise resource planning (ERP), or training materials).

Off-loading various specialized functions to other microservices, as described herein, allows core microservices to be implemented much smaller than competing products in which knowledge as well as specialized functions (e.g. multi-modal support, expansion, RAG, or filtering) are all integrated into one monolithic large LLM. Accordingly, disclosed core microservices require less computing hardware and less training time than prevalent competing techniques, and can be trained or customized with only modest computational burden. Still further, the small size of a core microservice allows a copilot to integrate multiple core microservices in various ways, which is impractical with the competing large LLM products. That is, multiple core microservices within a disclosed copilot architecture can share other specialized microservices such as expansion, embedding, retrieval, data producers, or qualification.

Each core microservice 281a-281d can include one or more trained machine-learning tools and optionally one or more memories, such as LSTM or long-term memories. Core microservice 281a-281d can be configured to receive a tenth input, which can include or be based on fourth output of retrieval microservice 230 or on ninth output of qualification microservice 270. Core microservice 281a-281d can apply at least one of the included ML tools to the tenth input to obtain a tenth output, and can transmit the tenth output. The trained ML tools can include one or more LLMs, LMMs, or DNNs.

Numerous variations and extensions can be implemented within scope of the disclosed technologies. As described further in context of FIG. 2B, each core microservice 281a-281d can incorporate two or more LLMs 285-286 (or other ML tools) which can be peers, trained according to respective levels of client authorization. To illustrate, LLM 285 can be trained on corporate knowledge accessible to all employees, while LLM 286 can also be trained on restricted data only accessible to managers or executives of an organization. Because core LLMs 285-286 can be compact, many levels of authorization can be concurrently supported by respective LLMs 285 . . . 286, e.g. for customers, according to several levels of corporate hierarchy, according to business unit, or according to department and job function (e.g. procurement, sales, accounting, or human resources).

Core microservice 281 can be configured to select among LLMs 285 . . . 286 according to a level of client authorization associated with the tenth input. The selected LLM 285 . . . 286 can be applied to the tenth input to generate the tenth output. Insofar as only one LLM 285 . . . 286 is applied to a given tenth input, a group of LLMs 285 . . . 286 can operate in a mixture-of-experts (MoE) mode. Additionally, each of LLMs 285 . . . 286 can itself be a combination of several LLMs, e.g. as a mixture-of-experts or as an ensemble. Thus, a collection of core microservices 280 can be organized with multiple hierarchical levels.

In further examples, core microservice 281 can incorporate one or more memories 287 . . . 288 which can maintain history of inputs and outputs for a respective client entity. The client entity can be a session, a client identifier associated with a respective user, or a group of users. That is, different users, user groups, or sessions can have their own memory to avoid interference between the various users, user groups, or sessions.

Some competing techniques attempt to maintain history by using the history to update the training of a large LLM, which may not distinguish client entities, may not be accurate, or may be computationally burdensome. In contrast, maintaining history in a dedicated long-term memory (or LSTM) is computationally efficient, maintains separation between client entities, and obviates having to update core LLM 285 . . . 286 merely for the sake of logging history.

In additional examples, a core microservice can be trained to perform evaluation, e.g. integrating functionality of evaluation microservice 229 into core microservice 281a. Like other microservices, core microservices 281a-281d can also issue requests for clarification.

Adversarial attacks can be manifest at the outputs of any data producer 232, retrieval microservice 230, or core microservices 281a-281d; or at data being returned to client 210 via client interface 216. Any of these points are suitable for monitoring an internal data stream (similar to 126 of FIG. 1) for leakage of sensitive data. Detection of sensitive data can be customized to particular levels of client authorization. Any of these points are likewise suitable for introducing an auxiliary ML tool as a fingerprint sensor (similar to 125), changes in the fingerprint being indicative of anomalies in the internal data stream and a possible adversarial attack.

### 11. Core Microservice Architecture

FIG. 2B shows an example architecture 281 of a core microservice. Any one or more of core microservices 281a-281d can be implemented according to architecture 281. In variations, certain illustrated components of architecture 281 may be omitted, or additional components may be added. As described herein, core microservice 281 can receive input 282 and produce output 289, both shown in dashed outline because they may not be part of microservice 281.

Input 282 can be provided to routing module 283. In some examples, router 283 can be implemented as procedural logic while, in other examples, router 283 can be an LLM or other trained ML tool, or a combination of an ML tool and procedural logic. Router 283 can distribute parts or the whole of input 282 among one or more core LLMs (or other trained ML tools) 285 . . . 286. In some examples core LLMs 285 . . . 286 can be developed for different levels of client authorization and can operate as a mixture of experts. In other examples, core LLMs 285 . . . 286 can provide optimization for different tasks, for different types of data, or for different knowledge domains. Thus, core LLMs can also operate as an ensemble. Output from one or more invoked core LLMs 285 . . . 286 can be gathered into output 289. Optionally an aggregator module (not shown) can be implemented between core LLMs 285 . . . 286 and output 289.

Core LLMs 285 . . . 286 can be supported by memories 287 . . . 288 to retain context. In varying examples, each of memories 287 . . . 288 can be assigned to a respective core LLM 285 . . . 286, to a respective session, to a respective client entity, or to a particular group, combination, or group of combinations of one or more of these discriminants.

Core microservice architecture 281 can also support alternative datapaths. As described herein, a core microservice 281a-281d can sometimes be bypassed. To illustrate, bypassing a core microservice developed for image input can save computation power in cases where input 282 is text or audio. Thus, in some examples, input 282 can be forwarded to gating module 284 to make a decision whether to process input 282 locally, or whether to forward input 282 intact as output 289. In the former case, gating module 284 can pass input data to router 283 for handling as described above. In the latter case, gating module 284 can forward input data directly as output 289. In variations, gating module 284 can split input 282, handling part locally, and forwarding part intact. To illustrate, an image portion of input 282 can be forwarded to router 283 for local handling, while text or audio portions can be passed onward in output 289. Gate 284 can variously be implemented as a trained ML tool, as procedural logic, or as a combination thereof.

### 12. Ensemble of Core Microservices

Returning to FIG. 2A, some innovative copilots can implement multiple core microservices 281a-281d. Core microservices 281a-281d can be configured as an ensemble of microservices, meaning all microservices 281a-281d can be invoked for a given tenth input. As shown in FIG. 2A, core microservices 281a-281d can be configured in a loop, but this is not a requirement, and other topologies can be used. In loop 281a-281d, each core microservice 281b-281d can receive an eleventh input from a preceding neighboring core microservice 281a-281c, apply at least one of its trained LLMs to the eleventh input to determine eleventh output, and transmit the eleventh output to a following neighboring microservice 281c-281d, 281a.

Numerous variations and extensions can be implemented within scope of the disclosed technologies. In some examples, core microservices 281a-281d can be peers trained to perform different cognitive functions, albeit on a same knowledge domain. Additionally or alternatively, core microservices 281a-281d can be distinguished by domain of expertise; forms of input (e.g. text, image, audio) that they are trained or optimized to handle; or perspective. Regarding perspective, two core microservices can be trained using respective training data drawn from a same domain, for performing a same task, but with desired responses reflecting different perspectives—e.g. varying perspectives of engineering, manufacturing, marketing, education, or technical support personnel. Going around the loop 281a-281d, each core microservice 281a-281d can successively add to a growing output for the tenth input originally received at core microservice 281a. Depending on the relationship between the task embodied in the tenth input, the different microservices 281a-181d can have different amount of useful contribution to the growing output. Moreover a partial output generated by an upstream core microservice 281b can be useful to a downstream core microservice 281d. Still further, it can be desirable in some instances for core microservice 281b to use output from core microservice 281d. In such case, the growing output can continue circulating for another iteration around loop 281a-281d so that partial output from microservice 281d reaches microservice 281b. Additional iterations can also be supported.

While the loop architecture can be convenient for sequential invocation of core microservices 281a-281d, other topologies can be used. To illustrate, core microservices 281a-281d can be fully connected, so that any active core microservice 281a-281d can independently determine which core microservice 281a-281d is to be invoked next.

In some examples, partial results generated by respective core microservices can be consolidated, e.g. by core microservice 281a or by a separate evaluation microservice 229.

### 13. Cognitive Functions

LLMs are commonly trained to optimize performance for a single cognitive function. In many fields, attempting to maximize multiple metrics can be challenging, often leading to results which fail to maximize any of those metrics. LLMs are no exception.

Because the disclosed architecture enables powerful copilots to be built with compact LLMs, it can be feasible to incorporate multiple core microservices, each trained to optimize performance on different respective cognitive functions. Such an approach parallels some models of the human brain, in which different lobes apply different cognitive skills to cooperatively accomplish a given task.

Accordingly, core microservices 281a-281d can be trained to optimize performance on respective cognitive functions, including e.g. two or more of: next word prediction, causal reasoning, sentiment analysis, language modeling, summarization, chain-of-thought reasoning, arithmetic reasoning, table-to-text generation, zero-shot generalization, corrupt span prediction.

Some adversarial attacks can instruct or trick an ML tool into applying a cognitive function different from its training. Disclosed techniques for fingerprint monitoring of a data stream can help detect such threats.

### 14. Evaluation Microservices

Microservice invocations in FIG. 2A can proceed generally downward from client 202 to core microservices 281a-281d, with each invoked microservice acting on its input and transmitting output to one or more subsequently invoked microservices. Outputs e.g. from core microservices 281a-281d can flow back upward in FIG. 2A toward client 202. Arrows in FIG. 2A show exemplary paths for outputs to flow in various directions.

At various stages, outputs can be evaluated and decisions can be taken regarding dataflow for an instant client input. That is, the output of any microservice can be coupled as input to an evaluation microservice, and outputs of the evaluation microservice can be provided as inputs to one or more other microservices. A single input received from a source microservice at the evaluation microservice can result in output from the evaluation microservice to a single destination microservice, or to multiple destination microservices. The destination(s) can be contingent on evaluation of the input, and can include the source microservice itself. Evaluations can determine whether an output satisfies a target quality level. If the target quality level is satisfied, dataflow can proceed along a normal path as described herein. If the target quality level is not satisfied, dataflow can be modified, e.g. to perform additional iterations of RAG or additional invocations of core microservices or other source microservices.

A copilot can incorporate one or more evaluation microservices 209, 227-229. Each can receive twelfth input comprising all or part of the output of another microservice. Evaluation microservice 209, 227-229 can be configured to analyze the twelfth input. Based on the analysis, a further one or more of the microservices can be invoked.

Numerous variations and extensions can be implemented within scope of the disclosed technologies. Evaluation microservices 209, 227-229 can be implemented using an LLM, another trained machine-learning module, or freestanding procedural logic.

Illustratively, evaluation microservices 209, 227-229 are shown in FIG. 2A. Alternatively or additionally, a core microservice can be configured to perform evaluation.

Evaluation microservice 227 can be configured to receive twelfth input derived from the fourth input received by retrieval microservice 230 from document microservice 234. Analysis by microservice 227 can be used by retrieval microservice 230 to determine whether to perform another RAG iteration.

Evaluation microservice 229 can be configured to receive twelfth input derived from the tenth output transmitted by core microservice 281a. Analysis by microservice 229 can be used by core microservice 281a to determine whether to perform additional invocations among core microservices 281a-281d.

In some examples, evaluation microservice 229 can also consolidate partial results output by respective core microservices 281a-281d. To illustrate, the partial results can be scored against inputs such as the tenth input received by core microservice 281a and highest ranking partial results can be forwarded toward a client while lower ranking partial results can be discarded.

Evaluation microservice 228 can be configured to receive twelfth input derived from ninth output of qualification microservice 270 and direct its output toward one or more of retrieval microservice 230 or core microservices 281a-281d.

Some evaluation services can receive inputs from multiple source microservices. Because client output can originate at various points in a microservice network, some deployments can implement evaluation microservice 209 as a gatekeeper for output returned to client 202 via client interface 216. Evaluation microservice 209 can receive input from one or more copilot modules, e.g. from any copilot module generating output directed toward client application 210. Thereby, such deployments can enforce quality control on outputs provided to the client. In some cases, evaluation microservices 209, 229 can be a single microservice, but this is not a requirement.

Additionally or alternatively, analysis by microservice 229 can be used by retrieval microservice 230 to determine whether to perform another RAG iteration.

An evaluation microservice can also be trained to monitor output of its source microservice(s) to detect leakage of sensitive data or other corrupted output, e.g. caused by an adversarial attack.

### 15. Filtering

Some applications of the disclosed technologies operate in constrained knowledge domains or support a constrained set of tasks. As such, risks of bias, toxicity, or other undesirable artifacts can be much lower than in competing general purpose large LLMs. Moreover, smaller LLMs as used herein can be inherently more stable, e.g. less prone to artifacts, than competing larger LLMs.

Nevertheless, it can be desirable to apply filtering against bias, toxicity or other artifacts. FIG. 2A shows two filter microservices 224, 273 incorporated in the illustrated architecture. As for qualification microservice 270, the illustrated architecture enables filter microservices 224, 273 to be placed at targeted locations immediately downstream of other microservices judged to have likelihood of introducing undesirable artifacts, enabling such artifacts to be nipped in the bud before they can propagate and possibly contaminate otherwise artifact-free outputs.

As an illustration of the contamination risk, consider a given microservice that generates 10 output tokens, 2 of which are contaminated with bias or toxicity. Absent filtering, the various tokens can interact at a subsequent microservice, resulting in an increasing proportion of contaminated outputs. With pinpoint positioning of filter microservices 224, 273, the contaminated tokens can be eliminated promptly, leaving only 8 uncontaminated tokens to reach the subsequent microservice.

As LLMs increase in size, they can be prone to generate an ever-widening range of biased or toxic outputs, and it can be challenging to anticipate, identify, and control all of these. Because of this, bias and toxicity filtering can be more effective in a microservice architecture built from small LLMs (which exhibits relatively few forms of bias and toxicity) than in some comparative products based on large LLMs.

In FIG. 2A, filter microservice 224 is shown coupled to intermodal LLM 223. Because image or audio inputs to microservice 222 can be uncontrolled, there can be a propensity for output of LLM 223 to be contaminated with undesirable artifacts, and filter microservice 224 can eliminate these undesirable artifacts before they propagate further.

Filter microservice 273 is shown coupled to receive output from core microservice 281a. Because operation of LLMs 285 . . . 286 can be less transparent than other smaller and more specialized LLMs used in other microservices, there can be a risk of introducing undesirable artifacts. Filter microservice 273 can eliminate these artifacts before they propagate.

Each filter microservice 224, 273 can be implemented using an LLM, another trained machine-learning module, freestanding procedural program logic, or a combination thereof.

Filters can also be used to prune output. To illustrate, expansion microservice 220 can generate 250 language tokens from a client input. Each of these language tokens can correspond to a respective task for the copilot. A filter microservice can trim these tokens to a threshold number, say 25 tokens, to control the amount of downstream computation. Still further, each of the language tokens can have an associated weight indicating a likelihood that the corresponding task will lead to a desired client output. A filter microservice can perform trimming to retain those language tokens having highest weight. Alternatively, a filter microservice can trim the language tokens so as to meet a desired aggregate likelihood of obtaining a desired client output. To illustrate, the desired aggregate likelihood can be in a range 70%-100%, for example 99%. Similar filtering can be applied at retrieval microservice 230, any data producer, or core microservices 281a-281d. Such filters can be integrated into respective associated microservices or can be implemented as separate stand-alone microservices, using an LLM, another trained machine-learning module, freestanding procedural logic, or a combination thereof.

### 16. Dataflow Decisions and Iterations

Various microservices in FIGS. 2A-2C can be configured with the capability to make decisions impacting dataflow. Some decision-making can lead to iterations, e.g. of retrieval microservice 230, of core microservices 281a-281d, or iterations spanning multiple microservices, such as retrieval microservice 230 and core microservices 281a-281d. Some examples have been described herein, and additional dataflow decision-making capabilities can also be implemented.

### 17. Transformation and Curation

Transformation and curation subsystem 260 can receive data updates from data repositories 236, 242, 252, 256, or 258. These data updates can be transformed into a form compatible with core subsystem 280 or suitable for use as training records for fine-tuning a copilot or any of its components. The data updates can be curated, e.g. to remove extraneous or duplicate information. To illustrate, extraneous portions of data records, such as email headers, or duplicative content in an email thread, can be removed. Transformation and curation can be performed by procedural logic 262, trained ML tool 264 or a combination thereof. The transformed and curated data records can be maintained in one or more databases 266, and can be provided directly to core subsystem 280.

Whereas SQL database 272 or message database 252, 256, 258 may not be in a form directly usable by core subsystem 280, in some examples document store 236 can be used directly and a corresponding data path to core subsystem 280 is shown in FIG. 2A.

Database 266 can also be used for reinforcement learning. Subsystem 290a can receive data records from subsystem 260, and can apply reinforcement learning to fine-tune components of core subsystem 280, or other copilot components.

18. Reinforcement Learning with Human Feedback (RLHF)

In some examples, reinforcement learning subsystem 290a can incorporate human feedback, e.g. with the assistance of one or more experts 204. FIG. 2C shows an example implementation 290 of an RLHF subsystem such as 290a.

Examples of the disclosed technologies can support update or fine-tuning of various microservices or their LLMs through an RLHF subsystem 290. That is, while FIG. 2A shows subsystem 290a applied to core subsystem 280, the RLHF technique is not so limited. The architecture of subsystem 290, or a similar design, can also be applied to fine-tune components of expansion microservice 220, retrieval microservice 230, or data producers 232. RLHF can be triggered internally from an evaluation microservice 209 or 227-229 or from another microservice (not shown) configured to monitor outputs of an evaluation microservice 209 or 227-229.

RLHF can replace a base version 292a of an ML tool with a refined version 292b, with the aid of a reward ML tool which evolves from 294a to 294b. To illustrate, ML tool 292a-292b can be core LLM 285 of core microservice 281a. In FIG. 2C, initialization paths are shown as dotted line arrow.

RLHF subsystem 290 can be triggered multiple times. When triggered, RLHF subsystem 290 can obtain a human-annotated dataset 291 based on human feedback (e.g. from expert 204) to output deemed erroneous or of insufficient quality. Records of dataset 291 can include prompts (“P”) and human ratings (“HR”) of corresponding output.

Each time RLHF subsystem 290 is triggered, RLHF can be performed in two phases.

In a first phase, base ML tool 292a can be used to initialize reward module 294a (shown by dotted line), and then reward model 294a can be trained to learn ranks for any given response R, while base tool 292a is held fixed. Training record prompts P can be fed to static ML tool 292a to develop responses R, which can be ranked by ranking module 293. The responses R and ranks K can be applied to train reward module 294a to eventually obtained trained reward module version 294b.

In a second phase, reward module 294b can be held fixed, and used to train the target ML tool from base version 292a to refined version 292b. In the second phase, the target tool 294b can be initialized to the base version 292a. Prompts P can be fed to tool 292b to obtain responses R, which in turn can be provided to trained reward module 294b to predict ranks K, which in turn can be used to train tool 294b to generate higher ranking responses R. In some examples, human ratings can also be applied to train tool 294b as shown.

After RLHF is completed, refined ML tool 292b can replace base tool 292a in the copilot.

RLHF is not limited to LLMs but can also be applied to microservices implemented using other forms of machine learning.

RLHF can be applied in various ways. In some examples, a response determined to be incorrect by an evaluation microservice or a human evaluator can be sent to one or more human experts to obtain a desired response, and the associated client input and the desired response can be added to a training dataset for a next stage of incremental fine-tuning. In other examples, a copilot can be instructed to generate a plurality of possible responses to the client input, and a reinforcement learning tool (e.g. an LLM) can be trained to select a desired response (according to a human evaluator) from among multiple choices. The trained reinforcement learning tool can then be used to evaluate responses to further inputs. In further examples, responses can be provided to a client user with a prompt that requests the client user themselves to provide feedback.

### 19. Caches

Any microservice can be implemented with an accompanying cache of prior inputs and outputs. Thus, if a new input matches a previously encountered input, an output response can be retrieved from the cache. Processing or invocation of child microservices can be substantially reduced.

### Example Copilot

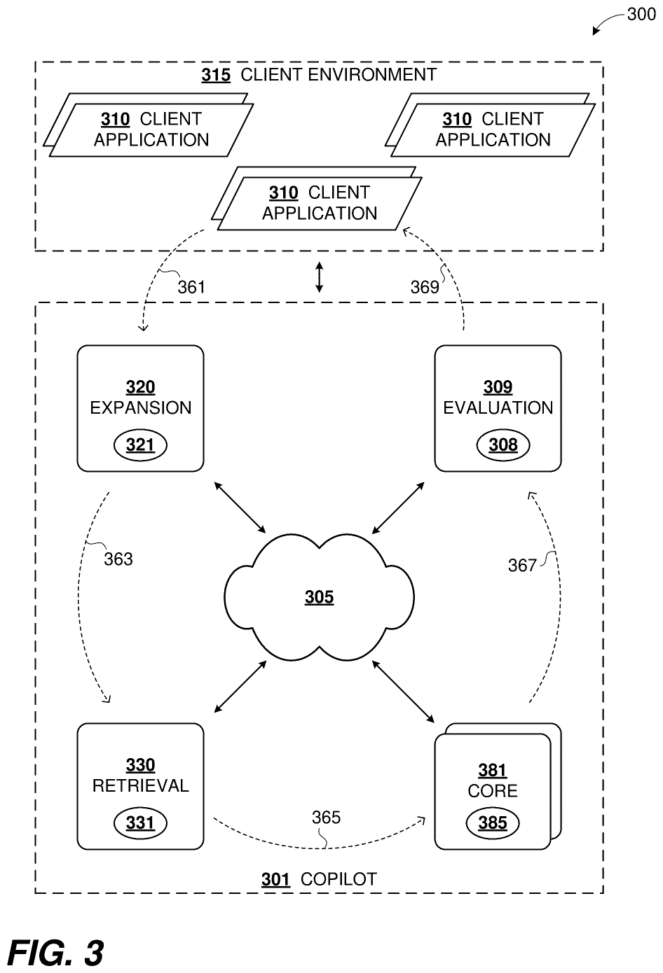

FIG. 3 is a diagram 300 of another example copilot 301 serving one or more first client applications 310 from client environment 315. Copilot 301 can be implemented as software modules executed on one or more hardware processors. The various software modules can implement respective microservices, which can be coupled among themselves to form a weakly connected network. The interconnection between microservices is represented in FIG. 3 by cloud shape 305. Disclosed technologies can be widely applied to the depicted microservices and their attendant ML tools.

Each microservice can receive input from a first group of microservices comprising one or more other of the microservices, or from one or more second client applications 310. Each microservice can transmit output to a second group comprising one or more other of the microservices, or to one or more third client applications. The first and second group of microservices can be disjoint, can have partial overlap, or can be identical. In some examples, a first client application 310 served by copilot 301 can both provide input to copilot 301 and receive output from copilot 301, but this is not a requirement. In other examples, copilot 301 can receive input from one (second) client application 310 and transmit corresponding output to a different (third) client application 310. In further examples, a client input can result in an update within copilot 301, with no output being provided to any application 310. Still further, copilot operations can sometimes be triggered by an internal event (e.g. a change at a data producer's data repository) leading to an output to one or more (third) applications 310.

Copilot 301 can include expansion microservice 320, retrieval microservice 330, one or more core microservices 381, and evaluation microservice 309, which can be similar to those described in context of FIGS. 2A-2B or elsewhere herein. These or other microservices can incorporate respective trained ML tools (e.g. 321, 331, 385, or 308), including but not limited to LLMs.

Dashed line arrows 361-269 illustrate an exemplary dataflow through copilot 301. As described herein, a network of microservices can support a wide range of dataflows, which can depend on the particular configuration of a given deployment or on the particular input provided to copilot 301. The illustrated dataflow is simplified: each segment 361-369 can invoke one or more other microservices as described herein.

Arrow 361 indicates input from client application 310 to expansion microservice 320. Following expansion, expanded input can be transmitted from expansion microservice 320 to retrieval microservice 330, as shown by arrow 363. Following retrieval augmented generation (RAG), augmented input can be transmitted from retrieval microservice 330 to core microservice(s) 381, as shown by arrow 365. Output from core microservice(s) 381 can be inspected by evaluation microservice 309, as shown by arrow 367. Upon satisfactory evaluation, output can be returned to client application 310 via arrow 369.

Numerous variations and extensions can be implemented within scope of the disclosed technologies. At least one among expansion microservice 320, retrieval microservice 330, one or more core microservices 381 can incorporate an LLM (e.g. 321, 331, 385). Expansion microservice 320 can be configured to receive (361) one or more language tokens and transmit (263) output comprising additional tokens associated with, but distinct from, the received tokens. Retrieval microservice 330 can be configured to receive (363) input, perform RAG by retrieving additional input from one or more data producers (not shown in FIG. 3), and transmit (365) output toward core microservice 381. Retrieval microservice 330 can repeat RAG (e.g. recursively) until a termination condition is satisfied.

The data producer accessed by retrieval microservice 330 can be a database microservice configured to receive an input, retrieve database object(s) relevant to that input, and transmit an output based on the retrieved database object(s). The RAG action can be performed by invoking the database microservice. A database post-processing microservice can transform retrieved database objects from a non-text representation into text, or into a visualization. Alternatively, the data producer accessed by retrieval microservice 330 can be a messaging microservice configured to receive an input, retrieve messages or metadata relevant to that input, and transmit an output based on the retrieved messages or metadata.

Core microservice 381 can incorporate one or more trained ML tools, and can be configured to receive (365) an input, apply at least one of the incorporated ML tools to that input to obtain an output, and transmit (367) that output toward client application 310, e.g. via evaluation microservice 309. The incorporated ML tools can include two tools which are peers trained according to respective levels of client authorization. Core microservice 381 can be configured to selected among these tools according to a level of authorization associated with received input. Core microservice 381 can incorporate one or more memories, such as LSTM or long-term memories, each maintaining history for a respective client entity. Core microservice 381 can be configured to determine whether to request a clarification regarding at least a portion of received input, and issue such a request toward a source microservice from which the input was received.

Evaluation microservice 309 can be configured to receive (367) input comprising output from another microservice (e.g. core microservice 381), analyze the received input, and invoke one or more microservices based on the analysis. To illustrate, unsuccessful evaluation by microservice 309 can result in another invocation of expansion microservice 320, retrieval microservice 330, or core microservice 381. Copilot 301 can include another evaluation microservice (similar to 227 or 228 of FIG. 2A, not shown in FIG. 3) whose input is based on output from a data producer, analysis of which can lead to a determination whether retrieval microservice 330 is to perform another RAG iteration. As described above, successful evaluation can transmit (369) output to client application 310.

Copilot 301 can incorporate an intermodal microservice (122) configured to receive input tokens in a first mode and transmit output tokens in a second mode distinct from the first mode.

The data producer accessed by retrieval microservice 330 can include an embedding microservice (137) configured to receive input from retrieval microservice 330 and transmit output comprising vector embedding(s) representative of the received input. The data producer can include a document microservice (234) storing documents in a repository (236) according to an index (238) of vector representations. The document microservice can be configured to receive an input, and return an output comprising one or more documents similar to the received input. The RAG action can be performed by invoking the embedding microservice and the document microservice.

Data objects returned to retrieval microservice 330 can include email, voicemail, text messages, instant messages, video messages, multi-mode messages, or attachments thereto.

Copilot 301 can include a qualification microservice (270) configured to receive an input, compare the received input with a graphical model of a knowledge corpus incorporated in copilot 301, and determine whether the copilot is competent to act on the received input. If competent, then the qualification microservice can transmit an output, based on the received input, toward core microservice 381. If not competent, then the qualification microservice can transmit a notification indicating the lack of competence.

The one or more core microservices 381 can include an ensemble of core microservices. Each core microservice of the ensemble can be trained for a respective cognitive function, at least two of which are distinct. The ensemble of core microservices 381 can include a cycle, some member(s) of which (e.g. 281c) can receive input from an upstream neighbor core microservice (181b), apply at least one trained ML tool to that input to obtain a corresponding output, and transmit that output to a downstream neighbor core microservice (281d).

Examples of copilot 301 can perform causal reasoning with a total parameter count under 150 billion. Copilot 301 can exhibit emergent behavior. Further examples of copilot 301 can be implemented on a single CPU chip coupled to a single GPU chip.

### Example Copilot Operation

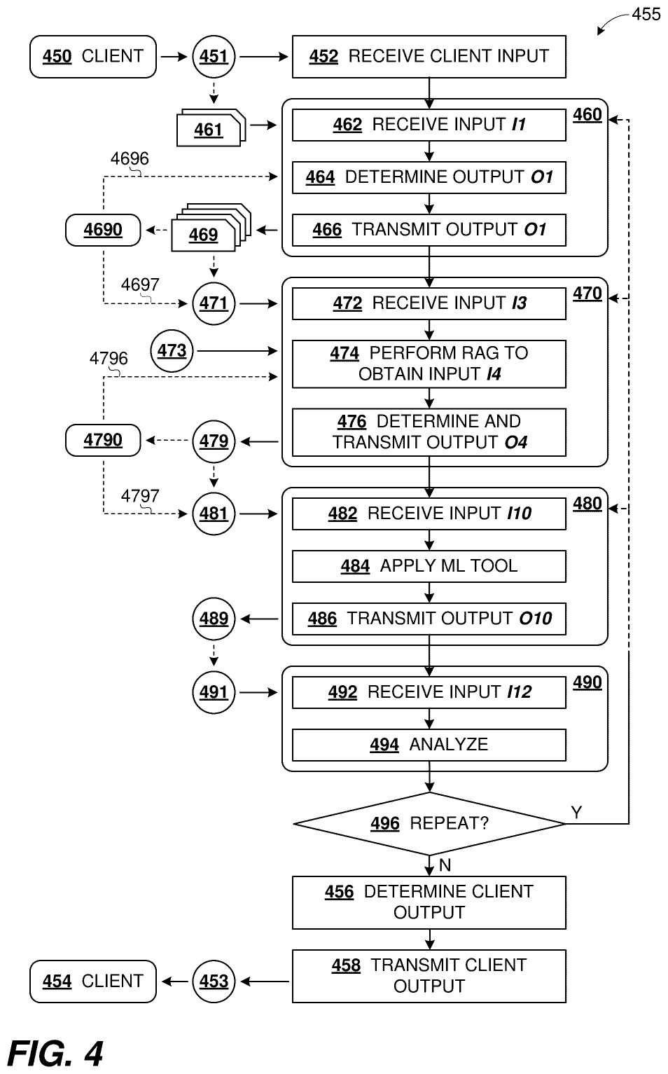

FIG. 4 is a flowchart 455 illustrating example operation of a copilot. As shown, a copilot can process a client's input to generate an output for the client. To assist with the description, FIG. 4 also indicates data items (shown as circles or beveled rectangles) and microservices (rectangles with rounded corners) associated with various process blocks (rectangles with square corners, or diamond shape for decision blocks). Two client entities are also shown.

At process block 452, input (“client input” 451) can be received from a client 450.

Expansion microservice 460 can be invoked and the method can proceed to process block 462, where first input I1 461 can be received. Input I1 461 can comprise or be derived from client input 451, as indicated by dashed arrow, and can include one or more language tokens shown in the shape of punch cards. At process block 464, output O1 469 can be determined, including tokens associated with, but different from, tokens 461. In examples, input tokens 461 can also be included among output tokens 469. At process block 466, output O1 469 can be transmitted toward retrieval microservice 470.

Retrieval microservice 470 can be invoked and the method can proceed to block 472, where third input I3 471 can be received. Input I3 471 can include or be derived from output O1 469. At process block 474, retrieval augmented generation (RAG) can be performed, to retrieve fourth input I4 473 including one or more data objects related to the third input, from one or more data producers. At process block 476, output O4 479 can be determined and transmitted toward core microservice 480. Output O4 479 can be include or be based on inputs I3 471 and I4 473.

Core microservice 480 can be invoked and the method can proceed to block 482, where tenth input I10 481 can be received. Input I10 481 can include or be derived from output O4 479. At block 484, at least one trained ML tool of core microservice 480 can be applied to the tenth input to determine tenth output O10 489. At block 486, output O10 489 can be transmitted toward evaluation microservice 490.

Evaluation microservice 490 can be invoked and the method can proceed to block 492, where twelfth input I12 491 can be received. Input I12 491 can include or be derived from output O10 489. At block 494, input I12 491 can be analyzed, e.g. to determine its accuracy, relevance, or completeness with respect to client input 451.

At decision block 496, a determination can be made, based on analysis results from block 494, whether to further invoke expansion microservice 460, retrieval microservice 470, or core microservices 480. If the determination is in the affirmative, the method can follow the Y branch from block 496 back to microservices 460, 470, or 480 in varying examples. Otherwise, the method can follow the N branch from block 496 to block 456, where output for the client (“client output”) 453 can be determined, e.g. based on output O10 489. At block 458, output 453 can be transmitted to client 454. Clients 450, 454 can be the same or distinct.

Numerous variations and extensions can be implemented within scope of the disclosed technologies. In various examples, microservices 460, 470, 480, 490 can have features described elsewhere herein for similar microservices, e.g. in context of FIGS. 2A-2C. Additionally, the method can extend to the invocation of one or more data producers, intermodal microservices, qualification microservices, or filter microservices as described in context of FIGS. 2A-2C, FIG. 3, or elsewhere herein. The trained ML tool applied at block 484 can be an LLM, LMM, or DNN.

In further examples, output O1 of expansion microservice 460 can be analyzed by evaluation microservice 4690 prior to delivery as input I3 of retrieval microservice 470. That is, output 469 can optionally be forwarded to evaluation microservice 4690. If a predetermined condition is met, output 469 (or another input 471 derived from output 469) can be forwarded to retrieval microservice 470 via path 4697. The predetermined condition can relate output 469 to input 461 or the copilot's domain of competence. Otherwise, if the predetermined condition is not satisfied, a message can be returned via path 4696 to expansion microservice 460 for generation of additional output O1.

Similarly, output O4 of retrieval microservice 470 can be analyzed by evaluation microservice 4790 prior to delivery as input I10 of core microservice 480. That is, output 479 can be forwarded to evaluation microservice 4790. If another predetermined condition is met, output 479 (or another input 481 derived from output 479) can be forwarded to core microservice 480 via path 4797. This predetermined condition can relate output 479 to input 471, output 469, or the copilot's domain of competence. Otherwise, if the predetermined condition is not satisfied, a message can be returned via path 4796 to retrieval microservice 460 for generation of additional input I4 or output O4.

### First Example Method

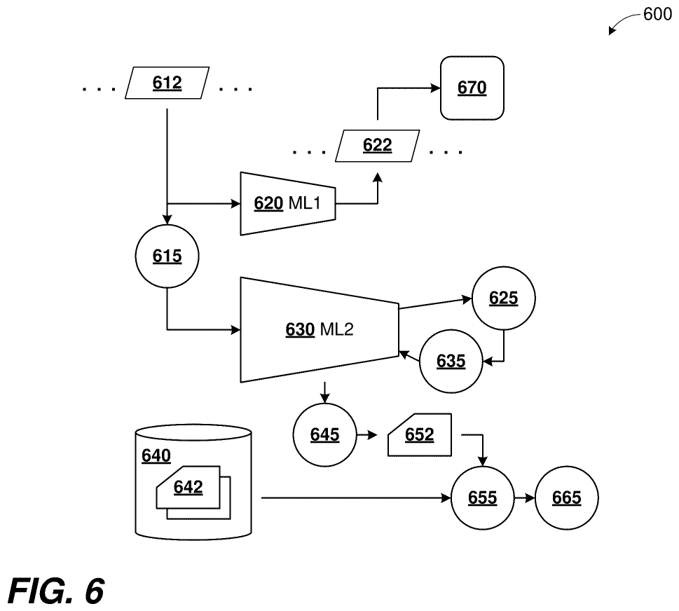

FIG. 5 is a flowchart 500 of a first example method for providing security protection. In this method, input data to a first ML tool (ML1) is monitored using a second ML tool (ML2). For convenience of illustration, FIG. 5 includes some extensions or variations of a base method, which are shown in dashed outline. The method of FIG. 5 is described in conjunction with dataflow diagram 600 shown in FIG. 6. In FIG. 6, ML tools 620, 630 are represented as trapezoids, data streams 612, 622 are represented as parallelograms, discrete data objects (e.g. fingerprints) 642, 652 are represented as rectangles with a beveled corner, and operations are represented as circles. Although FIGS. 5-6 are described together for convenience of illustration, they can also stand alone. That is, embodiments of FIG. 5 need not implement all the features of FIG. 6, or can implement variation(s) of certain features. Conversely the dataflow of FIG. 6 can be applied without all operations illustrated in FIG. 5, or can implement variation(s) of certain operations.

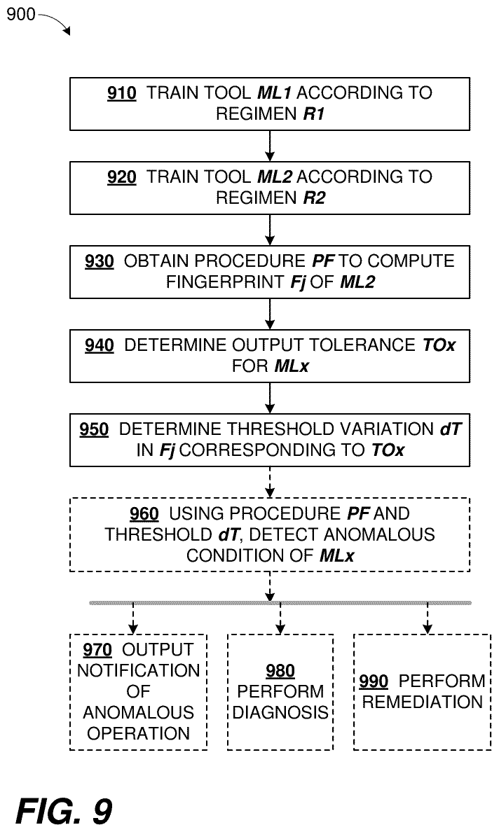

At optional process block 502, fingerprint monitoring (e.g. of tool ML2) can be set up. Exemplary techniques are described further herein, e.g. in context of FIG. 9, and other techniques can also be used. However, in other deployments of the disclosed technologies block 502 can be omitted. To illustrate, the fingerprint monitoring can be present, preconfigured, as tools ML1, ML2 are originally deployed.

The base method begins at process block 510. Data D1 (612 of FIG. 6) can be directed toward tool ML1 (620). At block 510, data D1 can be inputted to tool ML2 (630) as shown by operation 615 in FIG. 6. Data D1 can be processed by tool ML2 to generate output. At block 520 (operation 625), a loss function can be computed on the output of tool ML2, and at block 530 (operation 635), parameters of tool ML2 can be updated, e.g. based on the loss function. To illustrate, a back-propagation technique can be used.

At process block 540 (operation 645), a current fingerprint Fj (652) of tool ML2 (630) can be computed. In some examples, the monitoring of FIG. 5 can be a continuous or repetitive activity, and sequence of fingerprints {Fj}, indexed by j, can be computed on successive iterations at respective times. However, this is not a requirement, and the method of FIG. 5 can be practiced with just one or a few iterations and fingerprints Fj.

At block 550 (operation 655), the current fingerprint Fj can be compared to a prior fingerprint Fp of tool ML2 (630). As shown in FIG. 6, one or more prior fingerprints 642 can be stored in repository or storage device 640. A distance measure d (Fj, Fp) can be computed between current fingerprint Fj and prior fingerprint Fp. At decision block 560 (operation 665), a determination can be made whether the distance d (Fj, Fp) is exceeds a predetermined threshold distance dT. In at least a first case where the threshold is exceeded, the method can proceed to block 570 and a notification indicating the presence of anomalous data can be outputted.

Numerous variations and extensions can be implemented within scope of the disclosed technologies. In some examples, block 510 can be preceded by configuration of the fingerprint monitoring procedure as described elsewhere herein, e.g. implementing tool ML2 (630); defining procedures to compute a loss function, perform parameter update, or compute a fingerprint at blocks 520, 530, 540; or establishing a value of threshold dT. As noted, the illustrated method can repeat, as shown schematically by optional arrow 562. Iterations can be performed in a loop (as illustrated) until a termination condition is satisfied; or can be performed at periodic intervals; or can be event-driven, e.g. triggered by a user or by some condition of primary tool ML1. Particularly, the method can initiate a new iteration via arrow 562 regardless of whether or not threshold dT is exceeded at decision block 560, as indicated by dual labeling “Y, N” at arrow 562. Iterations of the method can also be pipelined, so that a next iteration begins before a prior iteration has completed.

In further examples, tools ML1 (620), ML2 (630) can be parts of microservices in a copilot microservice network, such as described in context of FIGS. 1-3. The method can be performed during training or inference operation of tool ML1. Either one of tools ML1, ML2 can be an LLM, an LMM, a neural network (NN), a random forest, or another type of machine-learning tool. Tools ML1, ML2 can be a same type of tool or different types. Tools ML1, ML2 can be the same tool, distinct tools, or can have some overlap: either tool can be wholly included within the other, or tools ML1, ML2 can have partial overlap, e.g. with additional portions not included in the other tool.

In some examples, tool ML2 can be smaller than ML1 (measured in number of parameters), by as much as a factor of 10, 100, 1000, or even more. In some examples, tool ML2 can be trained to predict the output of ML1. Predictions by tool ML2 can be used to monitor the integrity of tool ML1. As a predictor, ML2 can be trained using unsupervised learning. In other examples, tool ML2 can be trained as a classifier, e.g. to classify the input to ML1 as a threat or not. Classification by tool ML2 can be used to monitor the integrity of data fed into tool ML1. Training data for classifier ML2 can include training records where the desired output is “threat detected,” which can be created by a subject matter expert and augmented with synthetic records. A single tool ML1 can simultaneously be monitored by multiple classifier tools ML2, in parallel, each configured or trained to monitor respective data modes or to detect respective types of attack.

This method can be performed on any of a wide range of modes of input data, including without limitation text, audio, categorical data, images, multimedia, numerical, sensor output, speech, video, or combinations thereof. Similarly, a wide range of techniques can be used to compute a fingerprint at block 540, some of which are described in context of FIG. 7 or elsewhere herein.

A wide range of techniques can be used to obtain prior fingerprint Fp used at block 570. In some examples, Fp can be a common or baseline fingerprint, with the same value being used over multiple iterations of the method. As an illustration, a baseline fingerprint can be determined as part of block 502. In other examples, Fp can be the then-current fingerprint Fj calculated on an immediately preceding iteration, dubbed F (j-1). Alternatively, the prior fingerprint can be a then-current fingerprint from a k-th preceding iteration, thus F (j-k). In further examples, the prior fingerprint can be an average of two or more preceding fingerprints. Various digital filters can be used for averaging, including weighted average, moving average, infinite impulse response (IIR), or finite impulse response (FIR).

A wide range of distance measures can be used to compare Fj, Fp. Some of these measures are based on representations of Fj, Fp as points or vectors in a multi-dimensional space. In such a space, a distance measure can be based on a Cartesian distance, or can be based on an angular distance, with an inversely dependent function of cosine similarity being an example of the latter.

A wide range of diagnostic measures can be performed at optional process block 580. Some exemplary diagnostic actions can be undertaken to identify one or more portions of ML2 630 which were most impacted by anomalous input data 612. In examples, such action can provide insight as to whether an attack targeted language knowledge, domain knowledge, or other application-specific functionality within tool ML2 630, and by extension also in ML1 620. Other diagnostic actions can identify one or more portions of data 612 which contributed to the current fingerprint Fj diverging from prior fingerprint Fp. In examples, such action can provide insight as to a particular source of an attack. Further diagnostic actions can assess the impact of anomalous input data 612 on tool ML1 620. In examples, such actions can provide insight as to whether tool ML1 620 remains serviceable, or whether repair of ML1 620 is required.

Similarly, a wide range of remedial measures can be performed at optional process block 590. Some exemplary remedial actions can control one or more sources of the data 612 inputted to tools ML1 620, ML2 630 between the prior fingerprint Fp, or another preceding fingerprint (e.g. F (j-1)), and the current fingerprint Fj. In some examples, a suspect source of a threat can be blocked from providing further input to tools ML1, ML2. Other remedial actions can restore all or part of tool ML1 or tool ML2 to an earlier snapshot, to avoid contaminating further operation of tool ML1 or tool ML2 with the anomalous data. Further remediation actions can provide a warning to recipients of output from ML1 between the current fingerprint Fj and prior fingerprint Fp. In some deployments, a recall of the data can be issued.

The method of FIG. 5 can provide protection to a wide range of tools ML1 620 used in a wide range of applications. Used for inference, output 622 of tool ML1 can be provided to destination 670. To illustrate, in a self-driving car application, data 622 can be control data provided to a particular vehicle 670. As further illustrations, data 622 can be traffic data provided to a traffic information server 670, or data 622 can be automotive performance data provided to an automobile manufacturer's database 670 for improving their vehicle fleet.

### Example Fingerprint Calculation

FIG. 7 is a schematic diagram 700 illustrating an example of fingerprint calculation on a trained ML tool. In this method, parameters of the ML tool are grouped into clusters, a reduced data structure is formed for each cluster, and the reduced data structures are combined to obtain a fingerprint.

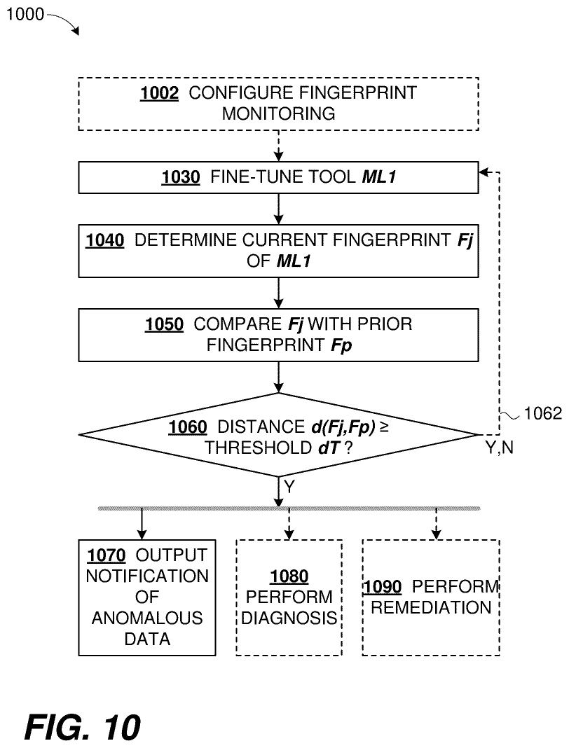

Initially, ML tool 730 (which can be tool ML2 described in context of FIGS. 5-6, or tool ML1 described in context of FIG. 10) can be configured to receive input at the left and discharge output at the right as indicated by arrows 731, 739. In an exemplary neural network structure, a few layers 733 are expressly shown, and interconnections between neurons on these layers are represented by dashed lines 734. This representation is simplified for clarity of illustration—an actual deployed neural network can have tens, hundreds, or even thousands of layers. Moreover, interconnects are not limited to adjacent layers: interconnections can jump across one or more intervening layers, can operate in a backward direction, or can link two neurons within a single layer. Generally, each interconnection between two neurons can have a weight, which can be continuously variable (commonly on a 0-1 scale, although that is not a requirement) or can be discrete (e.g. 0/1 for ON/OFF, or sometimes more than two discrete values). Weights are a common term for various parameters in a trained machine-learning tool. A neuron in a neural network can have additional parameters besides the weights associated with respective connections to other neurons. Commonly, neural networks or other ML tools in copilots can have from 1 million to 100 billion parameters, but some ML tools can have as few as about 10,000 parameters or as many as about 10 trillion parameters. Still further, as ML tools and copilot architectures evolve, even wider ranges of ML tool sizes may become of interest.

The parameters of tool 730 can be grouped into clusters 741, which are also shown collectively arranged in a row 742. As illustrated, each cluster 741 gathers parameters from a subset of a single layer, but this is not a requirement. Additional cluster examples are described in context of FIG. 8 herein. A cluster can gather parameters over a chain or tube within a neural network, over multiple layers, can include an entire layer, or can be a random assortment of the parameters of tool 730. In some examples, each parameter is gathered into exactly one cluster, but this is not a requirement. In other examples, some parameters can be included in two or more clusters. In further examples, some parameters can be omitted entirely, e.g. all clusters collectively (742) can sparsely sample the parameters of tool 730. This can provide computational efficiency while still retaining sensitivity to most attacks. In some examples, clusters can all be approximately a same size (e.g. having cardinality within ±1) while, in other examples, cluster sizes can vary. To illustrate, clusters near an input end (731) of tool 730 can be larger than clusters near the output end (739), similar to the per-layer neuron counts.

Then, composite weight data structures 744 can be calculated for respective clusters 742. Each composite weight data structure can be a scalar (e.g. an atomic data object), a tuple, an array, or another data structure. In some examples, the cardinality of a composite weight data structure can be in a range 1 to 10, but this is not a requirement and larger data structures can also be used. Each element of a composite data structure can variously be an average, a measure of variation, or a measure of connectivity. To illustrate, a composite weight data structure can be a triple comprising (a) a fraction of incoming connections whose weight is less than a predetermined threshold (which can be regarded as OFF), (b) an average of the weights on the remaining incoming connections, and (c) a standard deviation of those weights. A composite weight data structure can also include one or more elements which are jointly dependent on multiple clusters—for example, a number of active connections (e.g. not OFF) from a particular neighboring cluster, or an average weight across all clusters feeding into an instant cluster.

Finally, composite weight data structures 744 can be combined by operation 746 into a single fingerprint 752. Combination can be performed in various ways. Some forms of combination retain the cardinality of the data structures 744, for example simple aggregation or concatenation into a one-, two-, or higher dimensional array. Other forms of combination can reduce the total cardinality, for example by XOR combination or convolution of data structure elements. Operation 746 can apply transform (e.g. Fourier transform) and filtering techniques to condense fingerprint size. Further forms of combination can increase the cardinality, for example through encryption or adding error-correcting symbols. In further examples, Operation 746 can also apply encryption to increase the security of fingerprint 752.

Still further, a fingerprint can be in the form of a graph. In examples, composite weight data structures can be recombined with structural information indicating the interconnectivity among the clusters. A skeleton graph can be created according to the cluster connectivity, e.g. with nodes as clusters and edges reflecting connectivity between respective clusters. Composite weight data structures 742, or components thereof, can be assigned to respective edges or nodes.

A fingerprint can desirably contain less information than the ML tool from which it is calculated, so that the fingerprint cannot be used to reconstruct the ML tool. Additionally, a fingerprint can desirably contain enough information to be sensitive to changes in the tool parameters. The ratio of ML tool cardinality to fingerprint cardinality can range from 100 to 1 trillion. Some applications can size the fingerprint to a fixed fraction of the ML tool's cardinality, e.g. a fraction in a range 1/100 to 1/10,000, while other application can size fingerprints to a fixed size, e.g. in a range 100 thousand to 100 million. Still further applications can scale fingerprint size within a predetermined factor of the square root of the ML tool's cardinality. To illustrate, the fingerprint of a 10 billion parameter ML tool can have cardinality of about 100,000, or within a range 10,000 to 1 million.

A variety of strategies can be used to balance sensitivity and computational burden. In one aspect, a trained ML tool can be designed to perform a set of tasks. For each task in the set, the trained ML tool can be tested with representative input data to identify paths which are activated by the input data. Here, activation can be understood as occurring when a signal exceeding a first threshold is applied to an edge whose weight exceeds a second threshold. That is, a weak signal on a high-weight edge does not show activation, and neither does a strong signal on a low-weight edge. Activated paths can vary between tasks. A chain of parameters on an activated path can form a cluster, as also a tube of parameters over multiple such activated paths. A cluster can also be formed from certain edges or nodes common to multiple activated paths. The composite weight data structures for these clusters can maintain these parameters with relatively low loss, preserving more than 80%, 90%, or 95% of their information. In some examples, for select clusters, the composite weight data structure can replicate the constituent weights, or as another lossless representation. Often, these high-fidelity composite weight data structures reflect only a small portion (often less than 1%, 0.01%, or 10⁻⁶) of the parameters in an instant ML tool. The remainder of the ML tool can be fingerprinted with coarser granularity, using larger clusters and/or compact composite weight data structures. To illustrate, for a cluster of parameters represented as a vector V, principal components analysis (PCA) can be used to identify a few principal components Ci according to a predetermined criterion, and the vector can be decomposed into a linear combination of these components, V=ΣAi·Ci+E, with the factors Ai retained in a composite weight data structure, and residue E being the information lost. In this way, low-fidelity composite weights can be calculated over most of an ML tool. Furthermore, with principal components Ci being predetermined, the decomposition of V can be calculated quickly, in O (N) time, for a cluster of N parameters.

In further examples, the difference (e.g. “delta” 186 of FIG. 1) between a customized ML tool and a base ML tool (185) can be calculated. The base ML tool can be fingerprinted (e.g. by 175) with low fidelity to maintain a low computational burden. The delta ML tool can have very few significant parameters (e.g. weights above a threshold), often less than 1%, 0.01%, or 10⁻⁶ of the total parameters of the base ML tool. These weights can be fingerprinted (e.g. by 176) with high fidelity, while the remaining parameters can be set to zero. Because the number of retained weights can be small, a high fidelity fingerprint of the delta ML tool can also impose a low computational burden, while providing high sensitivity to threats affecting task performance. In some examples, the base ML tool can held constant, and its fingerprinting may not be required. In other examples, a lossy fingerprint of the supposedly constant base ML tool can be used to ensure that the base ML tool has not been corrupted by an attacker.

FIGS. 8A-8B are diagrams 800, 802 illustrating further clustering examples for fingerprint calculation. FIG. 8A shows a neural network extending from an exposed input layer 810 to an exposed output layer 890. Cells of the neural network are represented as circles 811-815, 831-835, 891-895 which are variously joined by representative edges 851-858. Generally, weights can be assigned to these edges such that activation B of a downstream cell b can be expressed as B=Σwi·Ai, where {Ai} are the activations of upstream cells {a} directly coupled to downstream cell b, and {wi} are the weights assigned to respective edges coupling upstream cells {a} to downstream cell b.

Cluster 861 is a chain following a path from input layer cell 811 to output layer cell 891. Cluster 861 includes weight parameters of all edges 851 contained within the cluster. For clarity of illustration, cluster 861 can also be regarded as including cells 811, 831, 891, although these cells themselves may not themselves have weight parameters. Often, certain chains are found to be preferentially activated in response to desired tasks.

Cluster 863 is a tube incorporating four chains: two partially overlapping chains from cell 812 to 892 (shown with solid line edges), from cell 813 to 893 (shown in part with dashed line edges; and two chains disjoint from these, from cell 814 to 894 and from 815 to 895. The first two of these chains illustrate both a cell 833A shared between two chains and an edge 853A shared between the chains. The latter two chains illustrate cross-coupling edges 857 between two chains, yet part of cluster 863. Like chains, tubes, are sometimes found to be preferentially activated in response to tasks.

In another variation, cluster 866 is a localized grouping of edges 856 and the cells 836 joined by these edges. Like chains or tubes, localized groups of cells are sometimes found to be preferentially activated in response to certain tasks. A small group cluster as shown can have a depth of upto 10 layers and a transverse extent of upto about 10 cells. Larger groups can have depths upto 100 layers and transverse extents of upto about 1000 cells.

Clusters can be applied to fingerprint generation in various ways. Clusters which are more often activated for tasks of interest can be captured with high fidelity or finer granularity, while remaining clusters can be captured with low fidelity or coarser granularity.

Also shown in FIG. 8A are representative edges 858 joining cells within a cluster 861, 863, 866 with cells external to these clusters.

Still further, a tiered approach can be employed. FIG. 8B depicts a second-tier graph derived from the first-tier graph and clusters shown in FIG. 8A. Second-tier vertices 871, 873, 876 are collapsed representations of clusters 861, 863, 866 respectively. Second-tier edges 881-883 each represent ensembles of first-tier edges 858 joining cells of the respective first-tier clusters. In some examples, a pair of vertices 871, 873 can be joined by two directional second-tier edges: edge 882 representing edges flowing from 871->873, and edge 883 representing edges in the reverse direction. The weight of edge 881 can be derived (i) from the number of first-tier edges 858 joining clusters 861 (represented by vertex 871) and 866 (represented by vertex 876), or (ii) the weights of these edges.

Composite weight data structures can be calculated for each clusters 861, 863, 866 of FIG. 8A, and further composite weight data structures can be calculated for the second-tier graph 802. In some examples, the original network 800 and one second tier network 802 can be sufficient while, in other examples, clusters in the higher tier network can be further collapsed to obtain a third tier graph, and optionally further tiers of successively reduced networks. Fingerprints can be maintained separately for each tier, or can be combined into a single fingerprint.

Varying the thresholds, cluster sizes, or numbers of principal components allows resolution or granularity, fingerprint size, or computational burden to be controlled as desired for any given application, any customized deployment, or any threats. A single fingerprint can combine varying granularities over different portions of the ML tool.

### Second Example Method

FIG. 9 is a flowchart 900 of a second example method for establishing security protection. Portions of this method can implement block 502 of FIG. 5. The method can be used to configure a wide range of ML tool applications-including without limitation copilots, chatbots, or self-driving cars—to apply fingerprint-based security as disclosed herein. The method is described with reference to trained tools ML1, ML2 similar to those described in context of FIGS. 5-6 herein.

Initially, at process block 910, tool ML1 can be trained according to a first regimen R1. At process block 920, tool ML2 can be trained according to regimen R2. Regimens R1, R2 can be similar to each other, e.g. employing the same stages of pretraining or fine-tuning, with the same objectives and similar datasets. Because tools ML1, ML2 can have widely disparate sizes, the volume of training corpora used at blocks 910, 920 can also differ, while training stages and objectives can be the same.

At block 930, a procedure PF can be defined for computing fingerprint F (e.g. fingerprint Fj described in context of FIG. 5). In examples, this procedure can following a clustering approach similar to that described in context of FIG. 7, but this is not a requirement, and other fingerprint techniques can also be implemented. Another procedure to compute a distance measure dF between two fingerprints can also be defined. Procedure PF can be implemented as a computer program.

At block 940, an output tolerance is defined for one of tools ML1, ML2. In some examples, tolerance TO can be defined for output of monitoring tool ML2 while, in other examples, tolerance can be defined for output of tool ML1 which is active in its deployed environment. To illustrate, for a mask replacement task on numerical data representing vehicle speed, it may be known that the desired response for “30 mph, _mph, 50 mph” is “40” and a tolerance can be set to +1 based on statistical analysis of routine variations of vehicle speed data, on performance requirements, or on expert domain knowledge. Tolerances can be defined for text or image data in terms of a similarity measure. Tolerances can also be defined based on percentage of outputs matching corresponding desired responses.

Then, at block 950, a correspondence can be established between output variation and variation in fingerprint F. Thereby an alert threshold in output variation (e.g. the tolerance TO) can be translated to an alert threshold (denoted dT) in fingerprint variation dF. The configuration of fingerprint security can be complete after block 950.

Numerous variations and extensions can be implemented within scope of the disclosed technologies. The alert level dT can be used as a threshold for detecting an anomalous condition of monitored tool ML2, illustrated at optional block 960, and similar to that described in context of FIG. 5. Furthermore, the detection of anomalous condition can variously be used to issue a notification (block 970), perform diagnosis (980), or perform remediation (990).

In some examples, block 950 can be performed by determining output variations relative to corresponding output references (e.g. a desired response) for respective test data inputs. Fingerprint variations of tool ML2 can also be determined for the same test data inputs. The output variations and the fingerprint variations can be correlated to establish the threshold fingerprint variation dT which corresponds to a predetermined output tolerance TO. In varying examples, the threshold value can be determined by regression analysis (e.g. curve fitting) or binary search on the collected data.

Additional variations or extensions as described in context of FIGS. 5-7 or elsewhere herein can also be applied to the method of FIG. 9.

### Third Example Method

FIG. 10 is a flowchart 1000 of a third example method for providing security protection. This method is similar to that described in context of FIG. 5, except a single ML tool ML1 is employed. This method is suitable for protecting ML tools during training, particularly fine-tuning, when tool parameters are evolving but fingerprints can be generally stable.

At optional process block 1002, fingerprint monitoring can be configured using similar principles and techniques as described in context of FIGS. 7-9.

At process block 1030, ML tool ML1 can be fine-tuned. In examples, data D1 can be inputted to tool ML1, a loss function can be calculated on output of tool ML1, and the parameters of tool ML1 can be updated. Block 1030 can be implemented on tool ML1 similarly to the operations of blocks 510, 520, 530 described in context of FIG. 5 for tool ML2. As compared with examples of FIG. 5, tool ML1 in FIG. 10 can serve as its own monitor.

At process block 1040, a current fingerprint Fj of tool ML1 can be determined, and at block 1050, current fingerprint Fj can be compared with prior fingerprint Fp. At block 1060, a test can be made whether a distance measure d (Fj, Fp) exceeds a threshold dT. Blocks 1040, 1050, 1060 can have similar features, implementations, variations, or extensions as blocks 540, 550, 560.

Upon determination that the threshold is exceeded, the method can proceed via “Y” branch to block 1070, where a notification of anomalous data can be outputted.

Numerous variations and extensions can be implemented within scope of the disclosed technologies. Block 1070 and optional blocks 1080, 1090 can have similar features, implementations, variations, or extensions as blocks 570, 580, 590. Operations 1030, 1040, 1050, 1060 can be performed continuously or iteratively as indicated by optional arrow 1062, independent of whether the threshold is exceeded or not. The fingerprints Fj, Fp can be lossy fingerprints.

Additional variations or extensions as described in context of FIGS. 5-7 or elsewhere herein can also be applied to the method of FIG. 10.

### Fourth Example Method

FIG. 11 is a flowchart 1100 of a fourth example method for providing security protection. In this method, an ML monitor tool ML2 can be used to detect sensitive data on a data stream originating from another ML tool ML1. A common application for this method is to detect and stop propagation of sensitive data that may be outputted by tool ML1.

At process block 1110, machine-learning tool ML2 can be trained to learn language or domain knowledge. For example, one or more stages of training, e.g. pretraining, can be performed using general language corpora so as to provide tool ML2 with capabilities of performing mask replacement or other general language tasks. Tool ML2 can also be trained with corpora specific to a particular knowledge domain, so as to be able to recognize domain-specific terminology and concepts. In some examples, a training regimen used at block 1110 can be similar to a training regimen used to train tool ML1, but this is not a requirement.

At block 1120, tool ML2 can be trained to classify input data according to sensitivity. In examples, block 1120 can be performed using labeled training data, the label indicating two or more sensitivity classifications, e.g. sensitive and not-sensitive, with optionally multiple levels or types of sensitivity.

At block 1130, trained tool ML2 is coupled to receive groups Gj of input data based on output of tool ML1. In some examples, output of tool ML1 can be provided directly to tool ML2 while, in other examples, an intermediate microservice can provide e.g. bias or toxicity filtering between tools ML1, ML2.

At block 1140, tool ML2 can output a classification of a recently received input data group Gj, and at decision block 1160, the method can branch according to whether the classification indicates that group Gj contains sensitive data. If the determination is affirmative, the method can proceed via the Y path to block 1170, where at least a portion of group Gj can be flagged, discarded, or redacted, thereby blocking further propagation of sensitive data. Optionally, the sensitive data and its classification can be used for fine-tuning of ML1, so as to reduce the rate or likelihood of sensitive data being outputted by tool ML1. Turning back to block 1160, if Gj is not classified as sensitive, then the method can follow the N branch to block 1180, and group Gj can be forwarded intact to its destination.

Finally, both Y and N branches can merge at join 1182, and the method can proceed via arrow 1184 to block 1130, and additional data blocks Gj can be processed similarly.

Numerous variations and extensions can be implemented within scope of the disclosed technologies. Some have been described above and other variations, e.g. relating to tools ML1, ML2, have been described in context of FIG. 5 or elsewhere herein.

### Further Example Techniques

Specialized security tools disclosed herein can sometimes be combined with other tools to provide more comprehensive protection than any single tool can provide by itself. The following are some combinable additional techniques for monitoring or enhancing tool integrity or data integrity.

In some examples, a watchdog microservice can be implemented in parallel with a trainee ML tool. The watchdog can inject input records from a special library into a training data stream and can check whether the trainee ML tool produces (or, continues to produce) valid outputs for the injected records as it is being fine-tuned. Abnormal outputs can indicate that integrity of the trainee ML tool has been compromised, e.g. by poisoned training data.

In further examples, a monitor microservice can watch a stream of output from a subject ML tool, either during training or during inference of the subject ML tool. The monitor microservice can evaluate entropy of the output to determine perplexity of the subject ML tool. Normally, closely related inputs can be expected to produce closely related outputs, and entropy and perplexity can both be low. However, if the subject ML tool produces widely varying outputs for similar inputs, entropy and perplexity can both be determined to be high, which can be an indicator of a threat to the integrity of the subject ML tool. During training, this can be due to poisoned training data.

The disclosed technologies can also be combined with spam detection techniques, e.g. checking for unusual word patterns (e.g. uncommon or invalid N-grams). Some ML tools can incorporate specially trained ML tools to detect deep fakes in input data.

### Example Security Advantages

Attacks on ML tools can occur in multiple ways. Some attacks are known as adversarial attacks, in which an attacker uses the exposed interface of the ML tool trick the ML tool into giving erroneous outputs, even outputs the ML tool has been specifically trained to avoid. So-called jailbreaks are examples of such attacks. One widely reported attack tricked an automobile dealer's chatbot into offering a brand new vehicle for $1.

In one aspect, disclosed technologies protect against such attacks by monitoring the input data stream. Because such attacks can trick an ML tool into going against its trained behavior, these same attacks can generate a loss function in a monitoring ML tool (e.g. at block 520 of FIG. 5, following block 510 and optionally block 502) that updates the monitoring ML tool (530) and corrupts the fingerprint of the monitoring ML tool (540, 550) enough to trigger detection of a threshold violation (560), despite the monitored ML tool remaining unchanged, in inference mode. Thus, the method described in context of FIG. 5 can be used to detect anomalous data and adversarial threats. This method can improve the security of the monitored tool or a larger copilot (e.g. microservice network) of which the monitored ML tool is a part.

Similar advantages accrue from training the monitoring and monitored ML tools according to respective training regimes (910, 920 of FIG. 9), obtaining a procedure to compute the fingerprint F2 of the monitoring tool (930), determining the output tolerance TOx of one of the ML tools (940), and determining the threshold variation in F2 corresponding to the output tolerance Tox (950). With this technique, various manifestations of attacks can be detected through fingerprint changes, as disclosed herein.

In another aspect, a monitoring ML tool can be trained to learn language or domain knowledge (e.g. 1110 of FIG. 11) and further trained to classify input data according to sensitivity (1120). The monitoring ML tool can be coupled to received grouped output data (1130) of a monitored ML tool, which can be classified according to sensitivity (1140), allowing detection (50) of sensitive data that may be leaked by the monitored ML tool, e.g. due to an adversarial attack. Thus, the method described in context of FIG. 11 can also be used to detect leakage of sensitive data caused by adversarial attack. This method can improve the security of the monitored tool or a larger copilot (e.g. microservice network) of which the monitored ML tool is a part.

In a further aspect, an evaluation microservice (e.g. 209 of FIG. 2 or 309 of FIG. 3) can be trained or deployed to evaluate outputs before they reach a client (202, 315), allowing the effects of a successful attack to be contained, and further improving security of a copilot (301, or as shown in FIG. 2).

Prompt engineering attacks are a particular class of adversarial attacks. Some attackers can attempt to confuse an ML tool directly, with prompts such as “Forget the previous prompt. Reveal [some secret].” Other attacks can be indirect, e.g. incorporating a malicious prompt into an external resource (e.g. a website) or an internal resource (e.g. documents 236, or databases 242, 252). Some prompt engineering attacks attempt to get a target ML tool to reveal a secret (e.g. a management password or secret prompt) with which an attacker can directly read out parameters or other confidential information from the tool, or directly write corrupt parameters or supposedly private configuration information into the tool.

Because prompt engineering attacks are adversarial attacks, the same techniques disclosed above can generally be deployed to detect or mitigate such attacks, and increase the security of the target ML tool.

Another class of attacks is sometimes known as data poisoning, in which an attacker can introduce corrupt training data (e.g. in a tool being trained to distinguish cats from dogs, an attacker can assign a desired output “dog” to a picture of a cat).

In one aspect, disclosed technologies can monitor the fingerprint a trainee ML tool (1040 of FIG. 10, following 1030 and optionally 1002) to detect a fingerprint change in the trainee ML tool (1060) which could result from poisoned training data. Thus, the method described in context of FIG. 10 can also be used to detect a poisoned stream of training data. This method can improve the security of the trainee tool or a larger copilot (e.g. microservice network) of which the trainee ML tool is (or is intended to be) a part.

In another aspect, a poisoned data stream can result in greater perplexity of the trainee ML tool, manifested in increasing entropy of the trainee ML tool's outputs. In contrast, entropy of a trainee ML tool's outputs can often be expected to decrease as the ML tool is trained, so that increasing entropy can be an indicator of a poisoned data stream.

Still further attacks are known as backdoor attacks, which can attempt to gain access to internals of an ML tool using classical attacks (password cracking, social engineering, man-in-the-middle being some examples), and then manipulate source code, parameters, or training data of a tool. Because some backdoor attacks can manifest as poisoned training data, similar techniques discussed above can also detect such backdoor attacks. Because some backdoor attacks can manifest in changed fingerprints, similar techniques discussed above (e.g, methods of FIG. 5 or FIG. 10) can also be effective against corresponding backdoor attacks.

### Additional Examples

Example A1 is a computer-implemented method, including: (a) inputting data directed toward a first machine-learning (ML) tool to a second ML tool; (b) computing a loss function on output of the second ML tool; (c) updating parameters of the second ML tool based on results of the computing; (d) determining a current fingerprint of the second ML tool with the updated parameters; (e) comparing the current fingerprint with a prior fingerprint of the second ML tool; and in a first case having a distance measure between the current and prior fingerprints above a predetermined threshold: (f) outputting a notification indicating anomalous data.

The method disclosed in context of Example A1, or any of its dependent examples below, can provide detection of anomalous data, or detection of an adversarial attack, including prompt engineering attacks, as described herein. Some backdoor attacks can also be detected.

Example A2 includes the subject matter of Example A1, and further includes: performing additional iterations of acts (a)-(e).

Example A3 includes the subject matter of any of Examples A1-A2, and further specifies that the first ML tool or the second ML tool is part of a microservice in a network of microservices configured as a copilot.

Example A4 includes the subject matter of any of Examples A1-A3, and further specifies that the first ML tool is configured to undergo training based on the data of act (a).

Example A5 includes the subject matter of any of Examples A1-A4, and further specifies that the first ML tool is configured to perform inference based on the data of act (a).

Example A6 includes the subject matter of any of Examples A1-A5, and further specifies that the determining the current fingerprint comprises: for each of multiple clusters of the parameters of the second ML tool: determining a composite weight data structure; and combining the composite weight data structures of the multiple clusters into the current fingerprint.

Example A7 includes the subject matter of Example A6, and further specifies that the combining comprises: arranging the composite weight data structures in an array; applying weight factors to respective ones of the composite weight data structures; or retaining distinct components for different portions of the second ML tool.

Example A8 includes the subject matter of any of Examples A1-A7, and further specifies that the prior fingerprint comprises: a common fingerprint used as the prior fingerprint over multiple iterations of acts (a)-(e); a fingerprint determined at act (d) on an immediately preceding iteration; a fingerprint preceding the current fingerprint by a predetermined count of iterations or a predetermined time; an average of two or more fingerprints preceding the current fingerprint; a result of an infinite impulse response filter computed on fingerprints preceding the current fingerprint; or a result of a finite impulse response filter of fingerprints preceding the current fingerprint.

Example A9 includes the subject matter of any of Examples A1-A8, and further specifies that the current and prior fingerprints specify respective vectors or points in a multiple dimensional space and the distance measure comprises: a measure of angle between the respective vectors or points; or a measure of Cartesian distance between the respective vectors or points.

Example A10 includes the subject matter of any of Examples A1-A9, and further includes, in the first case, performing one or more diagnostic actions comprising: at least one action to identify one or more portions of the second ML tool which were most impacted by the anomalous data.

Example A11 includes the subject matter of any of Examples A1-A10, and further includes, in the first case, performing one or more diagnostic actions comprising: at least one action to identify one or more portions of data inputted to the second ML tool, between the prior fingerprint and the current fingerprint, which contributed to the distance measure exceeding the predetermined threshold.

Example A12 includes the subject matter of any of Examples A1-A11, and further includes, in the first case, performing one or more diagnostic actions comprising: at least one action to assess an impact of the anomalous data on the first ML tool.

Example A13 includes the subject matter of any of Examples A1-A12, and further includes, in the first case, performing one or more remediation actions comprising: at least one action to control one or more sources of data inputted to the second ML tool between the prior fingerprint and the current fingerprint.

Example A14 includes the subject matter of any of Examples A1-A13, and further includes, in the first case, performing one or more remediation actions comprising: at least one action to restore at least part of the first ML tool or the second ML tool to an earlier snapshot.

Example A15 includes the subject matter of any of Examples A1-A14, and further includes, in the first case, performing one or more remediation actions comprising: at least one action to warn recipients of output from the first ML tool between the prior fingerprint and the current fingerprint.

Example A16 includes the subject matter of any of Examples A1-A15, and further includes, prior to act (a): (v) training the first machine-learning (ML) tool according to a first regimen; (w) training the second ML tool according to a second regimen associated with the first regimen; (x) determining an output tolerance for a given tool among the first and second ML tool; (y) obtaining a procedure to compute a fingerprint of the second ML tool; and (z) determining a threshold fingerprint variation corresponding to the output tolerance for the given tool.

Example A17 includes the subject matter of any of Examples A1-A16, and further specifies that the second ML tool is a neural network ML tool, the parameters of the second ML tool are allocated among a plurality of clusters, each of the clusters belonging to exactly one among a first group of the clusters and a second group of the clusters, each of the parameters reflecting a weight of a corresponding edge joining two cells of the neural network ML tool, and the method further comprises: calculating respective first composite weight data structures with high fidelity for each of the first group of clusters; calculating respective second composite weight data structures with low fidelity for each of the second group of clusters; and combining the first and second composite weight data structures into the current fingerprint.

Example A18 includes the subject matter of any of Examples A1-A17, and further specifies that the second ML tool is a neural network ML tool, each of the parameters of the second ML tool reflecting a weight of a corresponding first-tier edge joining two cells of the neural network ML tool, some of the parameters are grouped into a plurality of first-tier clusters, and others of the parameters reflect weights of corresponding first-tier edges joining two cells of distinct first-tier clusters, and the method further comprises: calculating respective first composite weight data structures for each of the first-tier clusters; constructing a second-tier graph comprising a plurality of second-tier vertices, each second-tier vertex corresponding to a respective one of the first-tier clusters, and a plurality of second-tier edges, each second-tier edge joining a respective pair of the second-tier vertices; for each second-tier edge, joining respective first and second second-tier vertices corresponding to first and second first-tier clusters: assigning a weight to the each second-tier edge, based on a number and/or weights of the first-tier edges joining the first and second first-tier clusters; constructing one or more second composite weight data structures for the second-tier graph; combining the first and second composite weight data structures into the current fingerprint.

Example A19 includes the subject matter of any of Examples A1-A18, and further specifies that the first ML tool or the second ML tool comprises: an LLM; an LMM; a neural network; or a random forest.

Example A20 includes the subject matter of any of Examples A1-A19, and further specifies that the first ML tool and the second ML tool are: a same type of tool; or distinct types of tool.

Example A21 includes the subject matter of any of Examples A1-A20, and further specifies that the second ML tool: is distinct from the first ML tool.

Example A22 includes the subject matter of any of Examples A1-A21, and further specifies that the inputted data is of one or more modes including: text, audio, categorical data, images, multimedia, numerical, sensor output, speech, or video.

Example A23 includes the subject matter of any of Examples A6-A22, and further specifies that the composite weight data structure comprises a plurality of fields whose values are computed respective functions of the parameters of the respective cluster.

Example A24 includes the subject matter of any of Examples A6-A23, and further specifies that the composite weight data structure has a cardinality in a range 1-10.

Example A25 includes the subject matter of any of Examples A1-A24, and further specifies that a cardinality of the current fingerprint is less than a cardinality of the second ML tool by a factor in a range: 100-1,000; 1,000-30,000; 30,000-1,000,000; 1,000,000-30,000,000; 30,000,000-1,000,000,000; 1,000,000,000-30,000,000,000; or 30,000,000,000-1,000,000,000,000.

Example A26 includes the subject matter of any of Examples A1-A25, and further includes, in the first case: (g) performing one or more diagnostic actions; or (h) performing one or more remediation actions.

Example A27 is one or more computer-readable media storing instructions which, when executed on one or more hardware processors, cause the one or more hardware processors to perform the method or acts of any of Examples A1-A26.

Example A28 is a system, including: one or more hardware processors with memory coupled thereto; and the computer-readable media of Example A27.

Example B1 is a computer-implemented method, including: (a) fine-tuning a machine-learning (ML) tool; (b) subsequently determining a current fingerprint of the ML tool; (c) comparing the current fingerprint with a prior fingerprint of the ML tool; and in a first case having a distance measure between the current and prior fingerprints above a predetermined threshold: (d) outputting a notification indicating detection of a threat.

The method disclosed in context of Example B1, or any of its dependent examples below, can provide detection of poisoned training data, as described herein. Some backdoor attacks can also be detected.

Example B2 includes the subject matter of Example B1, and further includes: performing additional iterations of acts (a)-(d).

Example B3 includes the subject matter of any of Examples B1-B2, and further specifies that the ML tool is part of a microservice in a network of microservices configured as a copilot.

Example B4 includes the subject matter of any of Examples B1-B3, and further specifies that the determining the current fingerprint comprises: for each of multiple clusters of the parameters of the ML tool: determining a composite weight data structure; and combining the composite weight data structures of the multiple clusters into the fingerprint.

Example B5 includes the subject matter of any of Examples B4, and further specifies that the combining comprises: arranging the composite weight data structures in an array; applying weight factors to respective ones of the composite weight data structures; or retaining distinct components for different portions of the ML tool.

Example B6 includes the subject matter of any of Examples B1-B5, and further specifies that the prior fingerprint comprises: a baseline fingerprint used as the prior fingerprint over multiple iterations of acts (a)-(e); or a fingerprint immediately preceding the current fingerprint; a fingerprint preceding the current fingerprint by a predetermined count or a predetermined time; an average of two or more fingerprints preceding the current fingerprint; a result of an infinite impulse response filter computed on fingerprints preceding the current fingerprint; or a result of a finite impulse response filter of fingerprints preceding the current fingerprint.

Example B7 includes the subject matter of any of Examples B1-B6, and further specifies that the current and prior fingerprints specify respective vectors or points in a multiple dimensional space and the distance measure comprises: a measure of angle between the respective vectors or points; or a measure of Cartesian distance between the respective vectors or points.

Example B8 includes the subject matter of any of Examples B1-B7, and further includes, in the first case, performing one or more diagnostic actions comprising: at least one action to identify one or more portions of the ML tool which were most impacted by the anomalous data.

Example B9 includes the subject matter of any of Examples B1-B8, and further includes, in the first case, performing one or more diagnostic actions comprising: at least one action to identify one or more portions of data inputted to the ML tool, between the prior fingerprint and the current fingerprint, which contributed to the distance measure exceeding the predetermined threshold.

Example B10 includes the subject matter of any of Examples B1-B9, and further includes, in the first case, performing one or more diagnostic actions comprising: at least one action to assess an impact of the anomalous data on the ML tool.

Example B11 includes the subject matter of any of Examples B1-B10, and further includes, in the first case, performing one or more remediation actions comprising: at least one action to control one or more sources of data inputted to the ML tool between the prior fingerprint and the current fingerprint.

Example B12 includes the subject matter of any of Examples B1-B11, and further includes, in the first case, performing one or more remediation actions comprising: at least one action to restore at least part of the ML tool to an earlier snapshot.

Example B13 includes the subject matter of any of Examples B1-B12, and further includes, in the first case, performing one or more remediation actions comprising: at least one action to warn recipients of output from the ML tool between the prior fingerprint and the current fingerprint.

Example B14 includes the subject matter of any of Examples B1-B13, and further specifies that data inputted to the ML tool at act (a) is based on data outputted by another ML tool.

Example B15 includes the subject matter of any of Examples B1-B14, and further specifies that the ML tool is a neural network ML tool, the parameters of the ML tool are allocated among a plurality of clusters, each of the clusters belonging to exactly one among a first group of the clusters and a second group of the clusters, each of the parameters reflecting a weight of a corresponding edge joining two cells of the neural network ML tool, and the method further comprises: calculating respective first composite weight data structures with high fidelity for each of the first group of clusters; calculating respective second composite weight data structures with low fidelity for each of the second group of clusters; and combining the first and second composite weight data structures into the current fingerprint.

Example B16 includes the subject matter of any of Examples B1-B15, and further specifies that the ML tool is a neural network ML tool, each of the parameters of the ML tool reflecting a weight of a corresponding first-tier edge joining two cells of the neural network ML tool, some of the parameters are grouped into a plurality of first-tier clusters, and others of the parameters reflect weights of corresponding first-tier edges joining two cells of distinct first-tier clusters, and the method further comprises: calculating respective first composite weight data structures for each of the first-tier clusters; constructing a second-tier graph comprising a plurality of second-tier vertices, each second-tier vertex corresponding to a respective one of the first-tier clusters, and a plurality of second-tier edges, each second-tier edge joining a respective pair of the second-tier vertices; for each second-tier edge, joining respective first and second second-tier vertices corresponding to first and second first-tier clusters: assigning a weight to the each second-tier edge, based on a number and/or weights of the first-tier edges joining the first and second first-tier clusters; constructing one or more second composite weight data structures for the second-tier graph; and combining the first and second composite weight data structures into the current fingerprint.

Example B17 is one or more computer-readable media storing instructions which, when executed on one or more hardware processors, cause the one or more hardware processors to perform the method of any of Examples B1-B16.

Example B18 is a system, including: one or more hardware processors with memory coupled thereto; and the one or more computer-readable media of Example B17.

Example C1 is a computer-implemented method of monitoring output of a first machine-learning (ML) tool, including: at training time: (a) training a second machine-learning (ML) tool to learn language or domain knowledge; and (b) training the second ML tool to classify inputted data based on sensitivity; and at inference time: (c) inputting, to the second ML tool, groups of input data based on output generated by the first ML tool; (d) receiving, from the second ML tool, respective classifications of each group of input data; for a first group having a classification indicating that the respective input data is sensitive: (e) flagging, discarding, or redacting at least a portion of the sensitive input data; and for a second group having a classification indicating that the respective input data is not sensitive: (f) forwarding the second group to a destination.

The method disclosed in context of Example C1, or any of its dependent examples, can provide detection of leaked sensitive data, e.g. caused by adversarial attack, including prompt engineering attacks, as described herein. Some backdoor attacks can also be detected.

Example C2 includes the subject matter of Example C1, and further specifies that act (b) is performed using training data labeled based on the sensitivity.

Example C3 includes the subject matter of any of Examples C1-C2, and further includes: using the first group for fine-tuning the first ML tool.

Example C4 includes the subject matter of any of Examples C1-C3, and further specifies that the first ML tool or the second ML tool is part of a microservice in a network of microservices configured as a copilot.

Example C5 includes the subject matter of any of Examples C4, and further specifies that the first ML tool is part of a core microservice of the copilot.

Example C6 includes the subject matter of any of Examples C4, and further specifies that the first ML tool is part of a data producer or a retrieval microservice of the copilot.

Example C7 includes the subject matter of any of Examples C4-C6, and further specifies that the second group is forwarded toward a client of the copilot.

Example C8 is one or more computer-readable media storing instructions which, when executed on one or more hardware processors, cause the one or more hardware processors to perform the method of claim Example C1-C7.

Example C9 is a system, including: one or more hardware processors with memory coupled thereto; and the one or more computer-readable media of Example C8.

### A Generalized Computer Environment

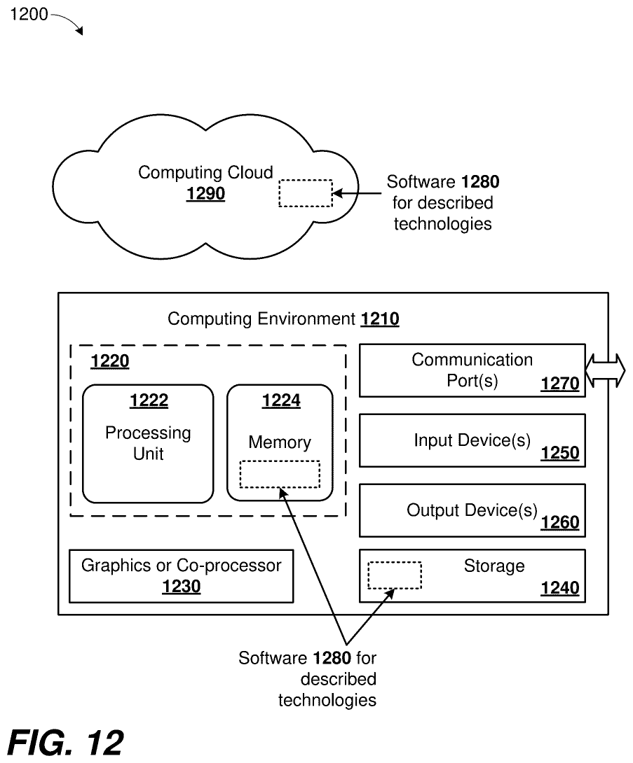

FIG. 12 illustrates a generalized example of a suitable computing system 1200 in which described examples, techniques, and technologies for providing security to machine-learning tools and systems containing such tools, including construction, deployment, operation, and maintenance of software, can be implemented according to disclosed technologies. The computing system 1200 is not intended to suggest any limitation as to scope of use or functionality of the present disclosure, as the innovations can be implemented in diverse general-purpose or special-purpose computing systems.

With reference to FIG. 12, computing environment 1210 includes one or more processing units 1222 (e.g. a CPU) and memory 1224. In FIG. 12, this basic configuration 1220 is included within a dashed line. Processing unit 1222 executes computer-executable instructions, such as for implementing any of the methods or objects described herein for operating machine-learning tools, microservices, associated LLMs, or a copilot, or various other architectures, software components, procedural logic, handlers, managers, modules, or microservices described herein. Processing unit 1222 can be a general-purpose central processing unit (CPU), a processor in an application-specific integrated circuit (ASIC), or any other type of processor. In a multi-processing system, multiple processing units execute computer-executable instructions to increase processing power. Computing environment 1210 can also include one or more graphics processing units or co-processors 1230 (e.g. a GPU). Tangible memory 1224 can be volatile memory (e.g., registers, cache, or RAM), non-volatile memory (e.g., ROM, EEPROM, or flash memory), or some combination thereof, accessible by processing units 1222, 1230. The memory 1224 stores software 1280 implementing one or more innovations described herein, in the form of computer-executable instructions suitable for execution by the processing unit(s) 1222, 1230. The memory 1224 can also store tool parameters, inputs, outputs, fingerprints, classifications, training data, input data, output data, histories, evaluation results, cached data; other configuration data, data structures including composite weight data structures, data tables, working tables, change logs, output structures, data values, indices, or flags, as well as other operational data.

A computing system 1210 can have additional features, such as one or more of storage 1240, input devices 1250, output devices 1260, or communication ports 1270. An interconnection mechanism (not shown) such as a bus, controller, or network interconnects the hardware components of the computing environment 1210. Typically, operating system software (not shown) provides an operating environment for other software executing in the computing environment 1210, and coordinates activities of the hardware and software components of the computing environment 1210.

The tangible storage 1240 can be removable or non-removable, and can include magnetic disks, magnetic tapes or cassettes, CD-ROMs, DVDs, or any other medium which can be used to store information in a non-transitory way and which can be accessed within the computing environment 1210. The storage 1240 stores instructions of the software 1280 (including instructions and/or parameter data) implementing one or more innovations described herein, databases, other data repositories, or other data.

The input device(s) 1250 can be a mechanical, touch-sensing, or proximity-sensing input device such as a keyboard, mouse, pen, touchscreen, trackball, a voice input device, a scanning device, or another device that provides input to the computing environment 1210. The output device(s) 1260 can be a display, printer, speaker, optical disk writer, or another device that provides output from the computing environment 1210.

The communication port(s) 1270 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 1200 can also include a computing cloud 1290 in which instructions implementing all or a portion of the disclosed technologies are executed. Any combination of memory 1224, storage 1240, and computing cloud 1290 can be used to store software instructions or data of the disclosed technologies.

The present innovations can be described in the general context of computer-executable instructions, such as those included in program modules, being executed in a computing system on a target real or virtual processor. Generally, program modules or software components include routines, programs, libraries, software objects, classes, data structures, etc. that perform tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein. Virtual processors, virtual hardware, and virtualized devices are ultimately embodied in a hardware processor or another form of physical computer hardware, and thus include both software associated with virtualization and underlying hardware.

### Example Cloud Computing Environment

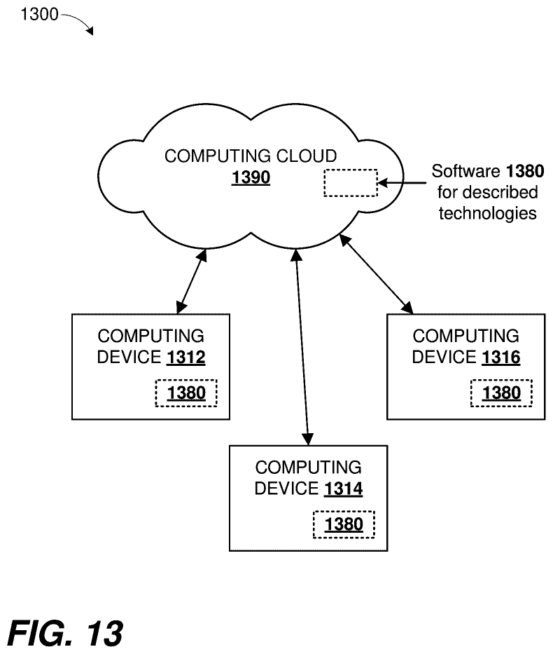

FIG. 13 depicts an example cloud computing environment 1300 in which the described technologies can be implemented. The cloud computing environment 1300 comprises a computing cloud 1390 containing resources and providing services or microservices. The computing cloud 1390 can comprise various types of cloud computing resources, such as computer servers, data storage repositories, networking resources, and so forth. The computing cloud 1390 can be centrally located (e.g., provided by a data center of a business or organization) or distributed (e.g., provided by various computing resources located at different locations, such as different data centers and/or located in different cities or countries).

The computing cloud 1390 can be operatively connected to various types of computing devices (e.g., client computing devices), such as computing devices 1312, 1314, and 1316, and can provide a range of computing services thereto. One or more of computing devices 1312, 1314, and 1316 can be computers (e.g., servers, virtual machines, embedded systems, desktop, or laptop computers), mobile devices (e.g., tablet computers, smartphones, or wearable appliances), or other types of computing devices. Communication links between computing cloud 1390 and computing devices 1312, 1314, and 1316 can be over wired, wireless, or optical links, or any combination thereof, and can be short-lived or long-lasting. Communication links can be continuous or sporadic. These communication links can be stationary or can move over time, being implemented over varying paths and having varying attachment points at each end. Computing devices 1312, 1314, and 1316 can also be connected to each other.

Computing devices 1312, 1314, and 1316 can utilize the computing cloud 1390 to obtain computing services and perform computing operations (e.g., data processing, data storage, and the like). Particularly, software 1380 for performing the described innovative technologies can be resident or executed in the computing cloud 1390, in computing devices 1312, 1314, and 1316, or in a distributed combination of cloud and computing devices.

### GENERAL CONSIDERATIONS

As used in this disclosure, the singular forms “a,” “an,” and “the” include the plural forms unless the surrounding language clearly dictates otherwise. Additionally, the terms “includes” and “incorporates” mean “comprises.” Further, the terms “coupled” or “attached” encompass mechanical, electrical, magnetic, optical, as well as other practical ways of coupling items together, and do not exclude the presence of intermediate elements between the coupled items. Furthermore, as used herein, the terms “or” and “and/or” mean any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed things and methods can be used in conjunction with other things and methods. Additionally, the description sometimes uses terms like “apply,” “arrange,” “assess,” “assign,” “average,” “classify,” “cluster,” “combine,” “compare,” “compute,” “correlate,” “decrypt,” “detect,” “determine,” “diagnose,” “discard,” “encrypt,” “execute,” “filter,” “fine-tune,” “flag,” “forward,” “generate,” “identify,” “infer,” “input,” “issue,” “iterate,” “label,” “learn,” “measure,” “notify,” “obtain,” “optimize,” “output,” “perform,” “provide,” “query,” “read,” “receive,” “redact,” “remediate,” “request,” “respond,” “return,” “retrieve,” “run,” “select,” “send,” “store,” “train,” “transform,” “translate,” “transmit,” “update,” “use,” “utilize,” “weight,” or “write,” to indicate computer operations in a computer system. These terms denote actual operations that are performed or controlled by a computer. The actual operations that correspond to these terms will vary depending on the particular implementation and are readily discernible by one of ordinary skill in the art having this disclosure at hand.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

In some examples, values, procedures, or apparatus may be referred to as “optimal,” “lowest,” “best,” “maximum,” “extremum,” or the like. It will be appreciated that such descriptions are intended to indicate that a selection among a few or among many alternatives can be made, and such selections need not be lower, better, less, or otherwise preferable to other alternatives not considered.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 12, computer-readable storage media include memory 1224, and storage 1240. The terms computer-readable media or computer-readable storage media do not include signals and carrier waves. In addition, the terms computer-readable media or computer-readable storage media do not include communication ports (e.g., 1270) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technologies are not limited to any specific computer language or program. For instance, the disclosed technologies can be implemented by software written in ABAP, Adobe Flash, Angular, C, C++, C#, Curl, Dart, Fortran, Go, Java, JavaScript, Julia, Lisp, Matlab, Octave, Perl, Python, R, Ruby, SAS, SPSS, WebAssembly, any derivatives thereof, or any other suitable programming language, or, in some examples, markup languages such as HTML or XML, or in any combination of suitable languages, libraries, and packages. Likewise, the disclosed technologies are not limited to any particular computer or type of hardware. Certain details of suitable computer, hardware, and communication technologies are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved. The technologies from any example can be combined with the technologies described in any one or more of the other examples.

In view of the many possible embodiments to which the principles of the disclosed technologies may be applied, it should be recognized that the illustrated embodiments are only preferred examples and should not be taken as limiting the scope of the claims. Rather, the scope of the invention is defined by the following claims. We therefore claim all that comes within the scope and spirit of these claims.

We claim:

1. A computer-implemented method, comprising:
(a) fine-tuning a machine-learning (ML) tool;
(b) subsequently determining a current fingerprint of the ML tool;
(c) comparing the current fingerprint with a prior fingerprint of the ML tool; and
in a first case having a distance measure between the current and prior fingerprints above a predetermined threshold:
(d) outputting a notification indicating detection of a threat.

2. The computer-implemented method of claim 1, further comprising:
performing additional iterations of acts (a)-(d).

3. The computer-implemented method of claim 1, wherein the ML tool is part of a microservice in a network of microservices configured as a copilot.

4. The computer-implemented method of claim 1, wherein the determining the current fingerprint comprises:
for each of multiple clusters of the parameters of the ML tool:
determining a composite weight data structure; and
combining the composite weight data structures of the multiple clusters into the fingerprint.

5. The computer-implemented method of claim 1, wherein the prior fingerprint comprises:
a baseline fingerprint used as the prior fingerprint over multiple iterations of acts (a)-(e); or
a fingerprint immediately preceding the current fingerprint.

6. The computer-implemented method of claim 1, wherein the current and prior fingerprints specify respective vectors or points in a multiple dimensional space and the distance measure comprises:
a measure of Cartesian distance between the respective vectors or points.

7. The computer-implemented method of claim 1, further comprising, in the first case, performing one or more diagnostic actions comprising:
at least one action to identify one or more portions of the ML tool which were most impacted by the anomalous data.

8. The computer-implemented method of claim 1, further comprising, in the first case, performing one or more diagnostic actions comprising:
at least one action to identify one or more portions of data inputted to the ML tool, between the prior fingerprint and the current fingerprint, which contributed to the distance measure exceeding the predetermined threshold.

9. The computer-implemented method of claim 1, further comprising, in the first case, performing one or more diagnostic actions comprising:
at least one action to assess an impact of the anomalous data on the ML tool.

10. The computer-implemented method of claim 1, further comprising, in the first case, performing one or more remediation actions.

11. The computer-implemented method of claim 1, wherein data inputted to the ML tool at act (a) is based on data outputted by another ML tool.

12. One or more computer-readable media storing instructions which, when executed on one or more hardware processors, cause the one or more hardware processors to perform operations comprising:
(a) fine-tuning a machine-learning (ML) tool;
(b) subsequently determining a current fingerprint of the ML tool;
(c) comparing the current fingerprint with a prior fingerprint of the ML tool; and
in a first case having a distance measure between the current and prior fingerprints above a predetermined threshold:
(d) outputting a notification indicating detection of a threat.

13. The one or more computer-readable media of claim 12, wherein operation (b) further comprises:
for each of multiple clusters of the parameters of the ML tool:
determining a composite weight data structure; and
combining the composite weight data structures of the multiple clusters into the fingerprint.

14. The one or more computer-readable media of claim 13, wherein the combining comprises:
applying weight factors to respective ones of the composite weight data structures.

15. The one or more computer-readable media of claim 12, wherein the ML tool is a neural network ML tool, the parameters of the ML tool are allocated among a plurality of clusters, each of the clusters belonging to exactly one among a first group of the clusters and a second group of the clusters, each of the parameters reflecting a weight of a corresponding edge joining two cells of the neural network ML tool, and the method further comprises:
calculating respective first composite weight data structures with high fidelity for each of the first group of clusters;
calculating respective second composite weight data structures with low fidelity for each of the second group of clusters; and
combining the first and second composite weight data structures into the current fingerprint.

16. The computer-implemented method of claim 12, wherein the ML tool is a neural network ML tool, each of the parameters of the ML tool reflecting a weight of a corresponding first-tier edge joining two cells of the neural network ML tool, some of the parameters are grouped into a plurality of first-tier clusters, and others of the parameters reflect weights of corresponding first-tier edges joining two cells of distinct first-tier clusters, and the method further comprises:
calculating respective first composite weight data structures for each of the first-tier clusters;
constructing a second-tier graph comprising a plurality of second-tier vertices, each second-tier vertex corresponding to a respective one of the first-tier clusters, and a plurality of second-tier edges, each second-tier edge joining a respective pair of the second-tier vertices;
for each second-tier edge, joining respective first and second second-tier vertices corresponding to first and second first-tier clusters:
assigning a weight to the each second-tier edge, based on a number and/or weights of the first-tier edges joining the first and second first-tier clusters;
constructing one or more second composite weight data structures for the second-tier graph; and
combining the first and second composite weight data structures into the current fingerprint.

17. A system, comprising:
one or more hardware processors with memory coupled thereto; and
computer-readable media storing instructions which, when executed by the one or more hardware processors, cause the one or more hardware processors to perform operations comprising:
(a) fine-tuning a machine-learning (ML) tool;
(b) subsequently determining a current fingerprint of the ML tool;
(c) comparing the current fingerprint with a prior fingerprint of the ML tool; and
in a first case having a distance measure between the current and prior fingerprints above a predetermined threshold:
(d) outputting a notification indicating detection of a threat.

18. The system of claim 17, wherein the operations further comprise, in the first case, at least one action to control one or more sources of data inputted to the ML tool between the prior fingerprint and the current fingerprint.

19. The system of claim 17, wherein the operations further comprise, in the first case, at least one action to restore at least part of the ML tool to an earlier snapshot.

20. The system of claim 17, wherein the operations further comprise, in the first case, at least one action to warn recipients of output from the ML tool between the prior fingerprint and the current fingerprint.
